(19) United States
(12) Patent Application Publication
(10) Pub. No.: US 2026/0156443 A1
(43) Pub. Date: Jun. 4, 2026

(54) ENHANCING EMERGENCY CALL SIGNALING WITH NAVIGATION INFORMATION FOR LOCATING AN EMERGENCY CALLER

(71) Applicant: Cisco Technology, Inc., San Jose, CA (US)

(72) Inventors: Srinath Gundavelli, San Jose, CA (US); Vikas Sanathana Murthy, Stockton, CA (US); Bart A. Brinckman, Nevele (BE); Matthew Stephen MacPherson, Cary, NC (US)

(21) Appl. No.: 18/965,548

(22) Filed: Dec. 2, 2024

(51) Int. Cl. H04W 4/90; G06Q 50/26; H04W 4/024; H04W 12/06; H04W 84/12

(52) U.S. Cl. CPC H04W 4/90; H04W 4/024; H04W 12/06; G06Q 50/265; H04W 84/12

(57) ABSTRACT

Provided herein are techniques to facilitate enhancing emergency call signaling to include navigation information for locating an emergency caller in a wireless local area network (WLAN). In at least one embodiment, a method is provided in which, for a wireless device capable of connection to a WLAN that has initiated emergency communications, obtaining via authentication of the wireless device for connection to the WLAN, map information that indicates an entrance for a structure at which the wireless device is located and a target location of the structure at which the wireless device is located; storing the map information in association with one or more index elements; and upon obtaining an emergency call for the wireless device including the one or more index elements, providing the map information to a service or device to enable navigation of emergency personnel to the target location of the structure.

### TECHNICAL FIELD

The present disclosure relates to network equipment and services.

### BACKGROUND

Networking architectures have grown increasingly complex in communications environments, particularly mobile networking environments. In particular, wireless local area networks (WLANs) are offered in many locations, such as malls and large public venues. With increased WLAN coverage in locations, it is important that users having mobile devices connected to WLANs can access and be provided public emergency services via WLAN connections. However, there are significant challenges with providing emergency services via WLANs.

### BRIEF DESCRIPTION OF THE DRAWINGS

FIG. 1A is a block diagram of a system that may be implemented to enhance emergency call signaling to include navigation information for locating an emergency caller in a wireless local area network, according to an example embodiment.

FIG. 1B is a diagram illustrating example details involving authentication signaling for an emergency call that can be enhanced to include navigation information associated with an emergency caller, according to an example embodiment.

FIG. 1C is a diagram illustrating example details for Session Initiation Protocol (SIP) signaling that can be used for initiating an emergency call by a wireless device, in accordance with an example embodiment.

FIG. 1D is a diagram illustrating example details for SIP signaling that can be enhanced to include navigation information that can be sent to a service or device to enable navigation of emergency personnel to an emergency caller, in accordance with an example embodiment.

FIG. 1E is a diagram illustrating example details for an example map that can be generated based on navigation information obtained via enhanced SIP signaling in which the map can display a navigation path to an emergency caller, in accordance with an example embodiment.

FIGS. 2A and 2B are a sequence diagram illustrating example operations that can be performed to provide emergency call signaling enhanced with location information for an emergency caller, according to an example embodiment.

FIG. 3 is a flow chart depicting a method according to an example embodiment.

FIG. 4 is a flow chart depicting another method according to an example embodiment.

FIG. 5 illustrates a hardware block diagram of a computing device configured to perform functions associated with operations discussed in connection with embodiments herein.

### DETAILED DESCRIPTION

### Overview

Embodiments herein provide for enhancing emergency call signaling for emergency calls made via a wireless local area network architecture (or in some instances via a private cellular architecture, such as Third Generation Partnership Project (3GPP) Fifth Generation (5G) architectures). The emergency call signaling can be enhanced to include integrated indoor navigation information or data that can be used to help direct emergency personnel to a caller's location within a structure (e.g., within a building, a large public venue (such as an arena, a mall, etc.), or the like).

In at least one embodiment, a method is provided in which, for a wireless device capable of connection to a wireless local area network (WLAN) that has initiated emergency communications facilitated by an identity provider (IDP), the method may include obtaining, by the IDP, via authentication of the wireless device for connection to the WLAN, map information that indicates an entrance for a structure at which the wireless device is located and a target location of the structure at which the wireless device is located; storing, by the IDP, the map information in association with one or more index elements; and upon obtaining, by the IDP, an emergency call communication for the wireless device including the one or more index elements, providing the map information to a service or device to enable navigation of emergency personnel to the target location of the structure at which the wireless device is located.

In at least one embodiment, a method is provided in which, for an authentication process involving connection of a wireless device to a WLAN for an emergency communication, the method may include determining a location of the wireless device within a structure at which the wireless device initiates the emergency communication; generating map information for the wireless device that includes an indication of a map of the structure, an entrance for the structure, and the location of the wireless device within the structure; and transmitting an authentication communication that includes the map information to an identity provider network.

### Example Embodiments

Buildings or structures, such as enterprise buildings, large public venues (LPVs), or the like are often vast and intricate. For example, an enterprise building can include multiple departments, offices, conference rooms, and facilities spread across several floors and structures. In these physical environments, navigating from one point to another can be challenging due to complex layouts, multiple floors, and/or a lack of visible signage.

These challenges can be magnified in emergency situations where time is of the essence. Emergency personnel, such as firefighters, paramedics, or security teams, often face significant delays in locating an emergency 911 caller, which can result in critical response time being lost.

The inability of emergency personnel to quickly and accurately navigate to a specific point of interest can lead to severe consequences, including loss of life, property damage, and loss of life.

Wireless radio access networks (RANs), such as private 5G and wireless local area networks (WLANs) (Wi-Fi® networks) often include support for indoor localization of a wireless device (often referred to as a station (STA) or client) connected to the network. Such networks are typically capable of identifying the precise location of a user/device indoors, often with sub-meter level accuracy. Protocols and techniques developed for such networks have greatly helped in improving the reliability and accuracy of indoor positioning.

Such localization/positioning techniques can be achieved through advanced indoor location technologies such as based on RTT (Round Trip Time), Time of Arrival (ToA) and/or Angle of Arrival (AoA) measurements at the radios in proximity to a wireless device connected to the network (e.g., to a radio access point (AP) or radio node of the network). For example, by analyzing time/angle differentials of communications/signaling at different radios, a wireless system can locate a user's position or geographic location within the building.

There are also other techniques such as Radio Frequency (RF) fingerprinting through which signal strength patterns can be mapped to specific locations of a building and stored in databases built through RF site survey(s) and/or dynamically constructed based on mobility patterns of wireless devices connected to a network.

Broadly, embodiments herein provide techniques to use location awareness of a wireless access network in conjunction with pre-configured/predefined structure information (e.g., floor maps, ingress/egress information, etc.) maintained for the network in order to generate a decorated or enhanced Uniform Resource Locator (URL) or Uniform Resource Identifier (URI) that includes navigation information indicative/representative of an indoor navigation path from an entrance/entry point of a structure (e.g., building) to an emergency caller (person in distress/wireless device) that has initiated/placed an emergency call via a WLAN (or P5G network); broadly, a starting point (structure entrance/entry point) and a target (caller). This decorated or enhanced URL/URI is signaled from the access network to an emergency identity provider (IDP or IdP) and can be retrieved by an emergency voice system during emergency call signaling. The routed emergency call, which is directed to a public safety answering point (PSAP) can included the embedded URL/URI (or a compressed/short URL/URI) in the call signaling header, as discussed for embodiments herein.

Generally, a URL is used as a location identifier and is a specific representation of a URI. However, a URI can be realized in other approaches in accordance with embodiments herein.

In various embodiments, the URL/URI can be encoded in a manner (e.g., as a string including any combination of alphanumeric and/or other characters) such that the URL/URI includes an identifier for a corresponding structure map for the structure in which the emergency caller is located, an entry point/entrance location identifier indicating an entrance to the structure (e.g., from the street, from another structure, etc.), and a destination location identifier indicating the location of the emergency caller within the structure. Other navigation information can be encoded in the URL/URI in accordance with embodiments herein. A generated URL/URI as discussed herein can be referred to as an ‘emergency navigation map URL/URI’.

In some embodiments, an emergency navigation map URL can be a Hypertext Transfer Protocol Secure (HTTPS or https) based URL, however, it is to be understood that other protocols, such as HTTP (HTTP or http), File Transfer Protocol (FTP), or the like may be utilized for an emergency navigation map URL.

In some instances, an emergency navigation map URL can be signaled/communicated to a navigation service in which the navigation service can generate (e.g., using a floor map of the structure based on the location of the emergency caller) navigation path information, such as a navigation path from the entrance of the structure to the location of the emergency caller in order to enable emergency services personnel to quickly/easily navigate to the caller. The digital floor map/navigation path can be sent to electronic devices (e.g., phones, tablets, etc.) of the emergency personnel and dynamically generated via one or more user interfaces (UIs) of the devices.

In some instances, the URL is signaled in Session Initiation Protocol (SIP) signaling. The URL can be inserted by voice functions (e.g., an emergency or enhanced-Call Session Control Function (E-CSCF)) of the IDP network. A receiver of the call (i.e., a callee), such as emergency services personnel, can receive this URL encoded into the caller identifier (ID) or as part of some other SIP header message. In some instances, the URL can point to a navigation service that can provide map(s)/instruction(s) for reaching the caller's location. In some instances, the callee can load this URL into a web browser, which can provide voice guided navigation/way-finding to enable the callee to reach the caller.

Thus, through embodiments presented herein enterprises, schools, or venue operators can be provided a simple web-based navigation service. When the URL is accessed, passing parameters that identify the caller location, a navigation service can steer the user. In some other examples, the voice server (e.g., E-CSCF) can distribute the URL to the public safety personal through out-of-band mechanisms.

It is noted that environments in which embodiments of the techniques discussed herein can be provided may include federation-based roaming architectures, such as the OpenRoaming federation-based architecture, through which IDPs along with Institute of Electrical and Electronics Engineers (IEEE) 802.11 (e.g., Wi-Fi) WLAN access network providers (ANPs) and/or P5G access network providers (e.g., enterprise entities such as business/corporate entities, government agencies, universities, institutions, etc.) can be configured to support emergency telecommunication services (e.g., emergency 911 (E911 or E-911) services or, in international settings, 999/112 services, etc.) over P5G/WLAN accesses.

The OpenRoaming federation makes extensive use of Roaming Consortium Organization Identifiers (RCOIs) for defining polices that are supported by particular access network providers (ANPs) and those policies supported by individual identity providers (IDPs). Generally, an OpenRoaming (OR) architecture is a federation that provides a framework for connecting radio access networks including WLAN (e.g., Wi-Fi) hotspots provided by access network providers (ANPs) with identity providers (IDPs or IdPs). An ANP may be considered any entity providing internet connectivity services via a RAN and an IDP may be considered an entity that manages identity credentials and policies for wireless devices via wireless profiles, such as Passpoint profiles, and provides authentications services for such wireless devices.

An RCOI can be a 3-octet or a 5-octet value that can be carried in an 802.11 beacon information element (IE) and/or can be sent via Access Network Query Protocol (ANQP) messages that can be used to identify the groups or identity providers that are supported by a given network (e.g., a given WLAN). Passpoint is a Wi-Fi Alliance (WFA) protocol through which Passpoint profiles provisioned for wireless devices enable such wireless devices to discover and authenticate to WLAN/Wi-Fi hotspots that provide internet access. A conventional Passpoint profile may include a user's identity and credentials, along with access network identifiers that can enable a user's wireless device to authenticate to an access network.

Supported RCOIs can be provisioned in WLAN equipment by ANPs and can be configured in the Passpoint profile of wireless devices managed by corresponding IDPs. During operation of a wireless device (also referred to interchangeably herein as a ‘mobile device’, a ‘wireless client’, station (STA), or variations thereof), an authentication exchange can be triggered with an IDP when there is a match of RCOIs between what is being broadcast by given a WLAN of an ANP and a Passpoint profile configured for a wireless device.

Broadly, such an identity federation-based roaming architecture that may that may provide emergency calling services for wireless devices via P5G/WLAN accesses can be enhanced in accordance with embodiments herein such that signaling of an emergency caller can be enhanced to include a URL (or URI) that includes navigation map information that may include data elements for an indoor navigation path that identifies, at least in part, an entrance of a structure (e.g., building) to the emergency caller (person) in distress/wireless device that has initiated/placed an emergency call via a given P5G/WLAN access.

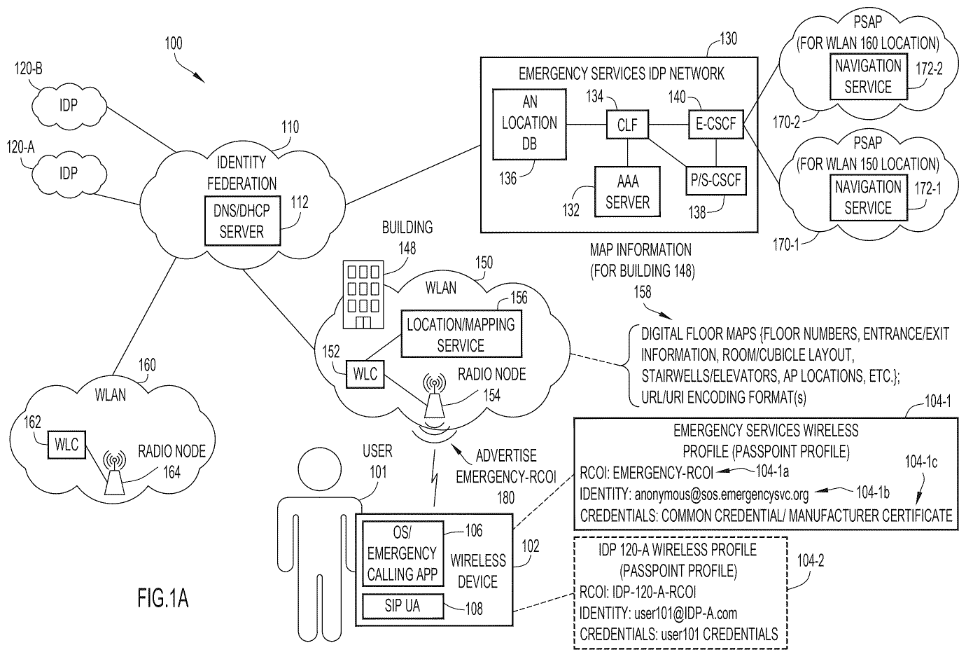

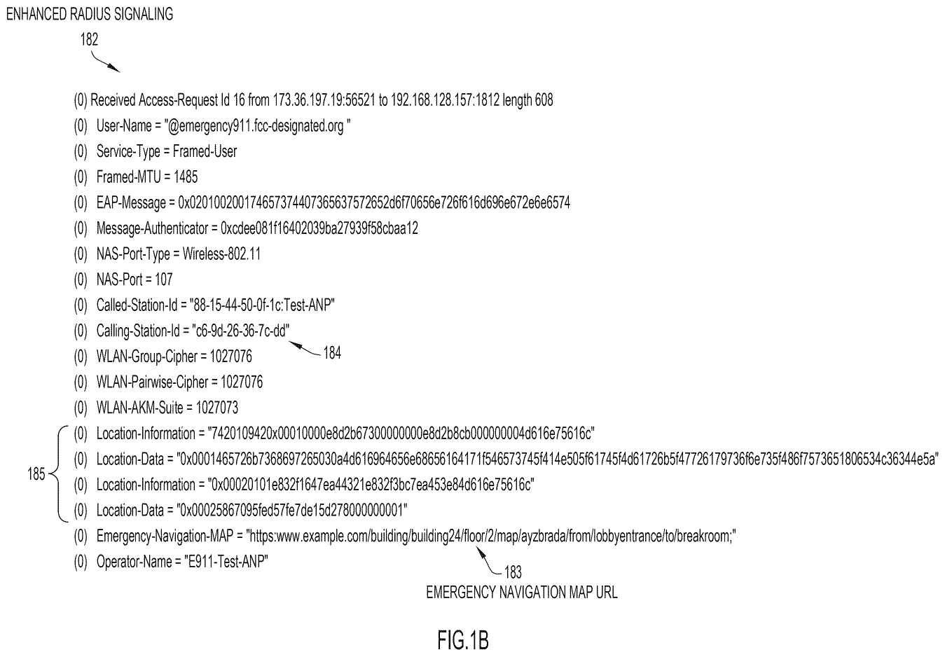

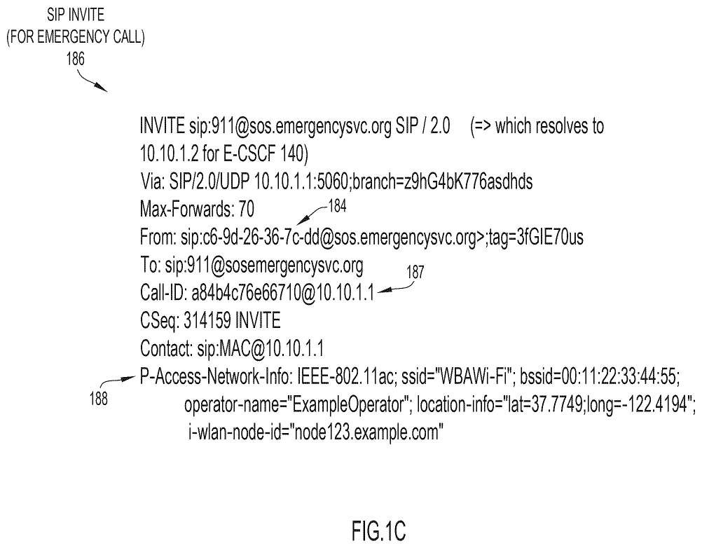

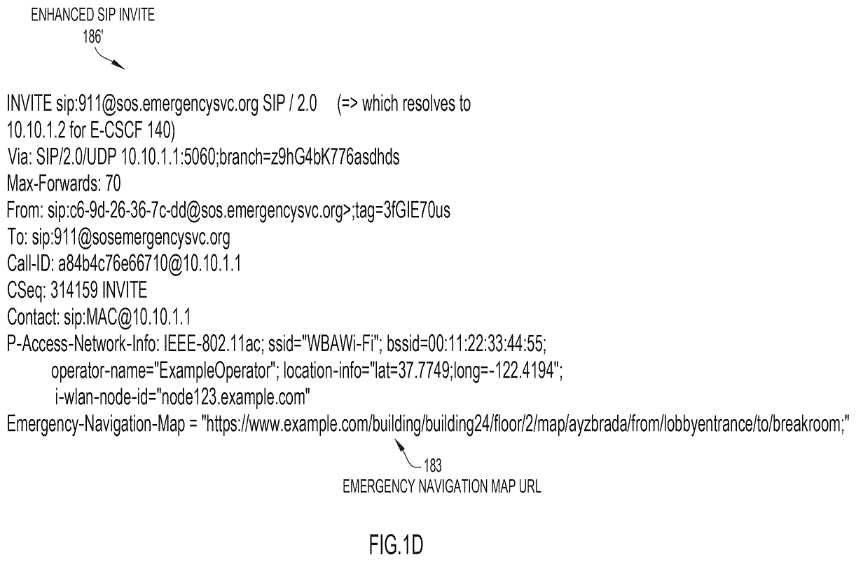

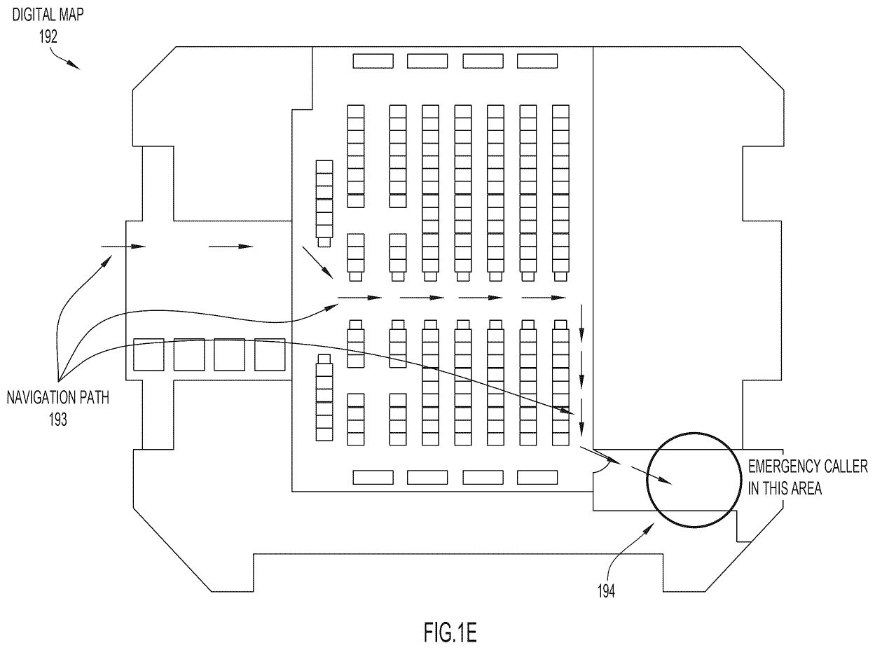

Referring to FIG. 1A, FIG. 1A is a block diagram of a system 100 that may be implemented to enhance emergency call signaling to include navigation information for locating an emergency caller in a WLAN, according to various example embodiments. As illustrated in FIG. 1A, system 100 may include a wireless device 102 that is operated by a user 101. The wireless device 102 may be configured or otherwise provisioned with one or more wireless profiles, such as Passpoint profiles, which are discussed in further detail herein, below.

FIG. 1B is a diagram illustrating example details involving authentication signaling for an emergency call that can be enhanced to include navigation information, according to an example embodiment, and is discussed with reference to FIG. 1A. FIG. 1C is a diagram illustrating example details for Session Initiation Protocol (SIP) signaling that can be used for initiating an emergency call by a wireless device, in accordance with an example embodiment, and is also discussed with reference to FIG. 1A. FIG. 1D is a diagram illustrating example details for SIP signaling that can be enhanced to include navigation information that can be sent to a service or device to enable navigation of emergency personnel to an emergency caller, in accordance with an example embodiment. FIG. 1E is a diagram illustrating example details for an example map that can be generated based on navigation information obtained via enhanced SIP signaling in which the map can display a navigation path to an emergency caller, in accordance with an example embodiment.

Also shown in FIG. 1A is an identity federation 110 (also referred to herein as identity federation entity), a number of wireless local area networks (WLANs), including a WLAN 150 and a WLAN 160, a number of identity providers (IDPs), including an IDP 120-A and an IDP 120-B, an emergency services IDP network 130, and a number of public safety answering points (PSAPs), such as a PSAP 170-1 that may include a navigation service 172-1 and a PSAP 170-2 that may include a navigation service 172-2.

In various embodiments, any combination of a Domain Name System (DNS) and/or Dynamic Host Configuration Protocol (DHCP) server, referred to herein as DNS/DHCP server 112, may be provided/configured for by the identity federation 110 (e.g., via any appropriate network, system, etc.). Although shown in relation to identity federation 110, it is to be understood that DNS/DHCP server 112 may be configured via any other network of system 100.

Each of WLAN 150 and 160 may include any number of radio nodes (sometimes referred to as access points (APs), wireless access points, Wi-Fi access points, or the like). In at least one embodiment, such radio nodes may be managed/operated or otherwise controlled via a corresponding wireless LAN controller (WLC), such as a radio node 154 configured for WLAN 150 that may be operated via a WLC 152, and a radio node 164 that may be controlled via a WLC 162 for WLAN 160. Although certain embodiments herein may be discussed with reference to WLC control of radio nodes for a WLAN, it is to be understood that embodiments herein may be equally applicable to controller-less WLAN implementations. It is to be understood that multiple wireless radio nodes can present in each of WLAN 150 and/or WLAN 160.

In at least one embodiment, WLAN 150 and WLAN 160 may each provide WLAN access connectivity for a given structure, such as a building, an LPV, etc. For example, WLAN 150 may be implemented for a building 148 to provide WLAN access network coverage for multiple floors of the building 148. Various example details are discussed in further detail herein with reference to WLAN 150, however it is to be understood that WLAN 160 can be configured/implemented in a similar manner as WLAN 150.

As shown in FIG. 1A, WLAN 150 can include a location service (or server) that can be configured to determine the location of a wireless device connected to/initiating an emergency call via WLAN 150 via any localization/positioning techniques now know to a person of skill in the art and/or hereinafter developed (e.g., RTT measurements, ToA measurements, AoA measurements, Time Difference of Arrival (TDoA) measurements, RF fingerprinting, mobility patterns, etc.). Further, a mapping service, which can be implemented with and/or may interface with a database (DB) can be configured for WLAN 150 that can be configured to generate an emergency navigation map URI/URL based on the location of an emergency caller and map information 158 for the structure (building 148) for which the WLAN 150 is implemented that can be stored/configured/maintained by the mapping service.

In at least one embodiment, a combined location/mapping service 156 is shown in FIG. 1A that can be configured to facilitate location and mapping services for WLAN 150 as discussed for embodiments herein. In some embodiments, multiple elements, functions, logic, nodes, etc. can be configured to facilitate location and mapping services for WLAN 150. In various embodiments, location/mapping service 156 can be combined with/implemented via WLC 152 or via radio node 154. In various embodiments, location/mapping service or functions associated therewith can be distributed across WLC 152 and radio node 154.

In various embodiments, map information 158 can include digital floor maps of floor(s) of the building 148, such as floor numbers, entrance/exit information, room/cubicle layout, stairwell/elevator information, access point (AP) locations, and/or any other floor map information that can be used to generate an emergency navigation map URL/URI. In at least one embodiment, map information 158 can further include one or more URL/URI formats that may specify the information and format thereof to be included in an emergency navigation map URL/URI that may be generated by the location/mapping service 156. In some embodiments, an emergency navigation map URL can be a HTTPS based URL, an HTTP based URL, an FTP based URL, or the like. Thus, WLAN 150 can be enhanced such that it can be configured with indoor digital floor maps that include clear markings of entry/exit points of a structure/facility, such as building 148.

Emergency services IDP network 130 may include a Remote Authentication Dial-In User Service (RADIUS) server, such as an Authentication, Authorization, and Accounting (AAA) server 132, a Connectivity Location Function (CLF) 134 (sometimes referred to as a Connectivity session Location and repository Function), an access network (AN) location database (DB) 136, a proxy/serving-Call Session Control Function (P/S-CSCF) 138, an emergency or enhanced-Call Session Control Function (E-CSCF) 140. Although not shown in FIG. 1A, in some instances a Routing Determination Function (RDF) can also be provided for emergency services IDP network 130. Further, in some instances, AN location DB 136 can be combined/integrated into the CLF 134.

In at least one instance, PSAP 170-1 may be considered the serving PSAP for civic/geographic locations covered, at least in part, by WLAN 150 and PSAP 170-2 may be considered the serving PSAP for civic geographic locations covered, at least in part, by WLAN 160.

AAA server 132 may support authentication for an emergency telecommunication services realm (e.g., “@sos.emergencysvc.org” or the like) and policies for an emergency-RCOI, as discussed in further detail herein. P/S-CSCF 138 and E-CSCF 140 may collectively be referred to herein as P/S/E-CSCF server 138/140 and may be considered a dedicated P/S/E-CSCF provided via emergency services IDP network 130 in order to support emergency telecommunication services via IP Multimedia Subsystem (IMS) protocols, such as Session Initiation protocol (as prescribed at least by 3GPP Technical Specification (TS) 24.229, and/or enhancements to such services, as discussed for embodiments herein.

In at least one embodiment, emergency services IDP network 130 may be managed by a government/emergency services provider, such as the Department of Homeland Security (DHS) or any other entity that may manage 911 service, or may be provided by any third-party providers (e.g., IDP-as-a-service (IDPaaS) providers, mobile network operator (MNO) providers, voice service providers, standards-based providers (e.g., the Wireless Broadband Alliance (WBA)), and/or the like may host these services on the behalf of a government or emergency service provider. In some embodiments, enterprise providers may also be able to provision this profile along with other enterprise policies over mobile device management (MDM) operations.

Generally, identity federation 110, including DNS/DHCP server 112 may interface with IDPs, such as IDP 120-A and IDP 120-B, WLANs 150 and 160, and emergency services IDP network 130, which may further interface with PSAP 170-1 and PSAP 170-2. Each of WLAN 150 and WLAN 160 may further interface with emergency services IDP network 130 via network connectivity/communications facilitated by the identity federation 110. Regarding emergency services IDP network 130, AAA server 132 may interface with CLF 134, which can further interface with AN location DB 136, P/S-CSCF 138, and E-CSCF 140. E-CSCF 140 may further interface with P/S-CSCF 138, PSAP 170-1, and PSAP 170-2. Although illustrated in FIG. 1A as separate network elements, in some embodiments, the AAA server 132 may be enhanced to include functionality of CLF 134 in order to facilitate a combined AAA server/CLF 132/134.

Generally, a PSAP may be considered a facility at which emergency calls are received under the responsibility of a public or government authority. A conventional CLF can maintain mappings between an endpoint's (wireless device's) dynamically assigned IP address and the endpoint's physical location. However, enhancements to the conventional services can be provided in accordance with embodiments herein in order to facilitate generating mapping information that can be provided to emergency personnel to aid in the personnel locating an emergency caller within a structure (e.g., building, LPV, etc.).

For the embodiment of FIG. 1A, WLANs 150 and 160 may each be operated by a corresponding access network provider (ANP) and the IDPs, including IDP 120-A, IDP 120-B, and emergency services IDP network 130 may collectively be considered a federation-based (or identity federation-based) roaming architecture facilitated via identity federation 110 involving identity federation-enabled signaling endpoints. Thus, WLAN 150 may be referred to as an ANP and WLAN 160 may also be referred to as another ANP in accordance with embodiments herein. In one embodiment, identity federation 110 may be implemented as an OpenRoaming federation entity involving OpenRoaming enabled signaling endpoints. The signaling communication between peers of WLAN 150, WLAN 160, and any of IDPs 120-A, 120-B, and emergency services IDP network 130 can be secured using mutual authentication based on the certificates issued under the WBA private PKI (public key infrastructure) operations.

Generally, an identity federation-based roaming architecture, such as an OpenRoaming architecture, may provide a federated wireless access service operated under the WBA framework. Such an identity federation-based roaming architecture may provide seamless onboarding of devices across participating access networks and identity providers. Thus, an identity federation-based roaming architecture, such as the OpenRoaming architecture, as facilitated via embodiments herein can include multiple access network providers and multiple identity providers to enable emergency telecommunication services.

Generally, for an identity federation-based architecture, end users/wireless devices that have been provisioned with a full wireless (e.g., OpenRoaming/Passpoint) profile can successfully authenticate onto a federation-based access network facilitated by an ANP using a standard IDP provisioned profile and an (OpenRoaming) RCOI.

For example, in at least one embodiment, an IDP 120-A wireless profile 104-2 can be configured for wireless device 102 by IDP 120-A and includes an identity and credentials for user 101/wireless device 102 that may facilitate connection/authentication of wireless device 102 to a WLAN using the wireless profile.

To facilitate emergency telecommunication (calling) services, an emergency-Roaming Consortium Organizational Identifier (RCOI) can be defined for emergency use. Such an emergency-RCOI can be referred to herein as an “E-911-RCOI” or “E-RCOI,” however, it is to be understood that any emergency-RCOI may be utilized in accordance with embodiments herein.

An emergency-RCOI may be any unique 3-octet or 5-octet value or string that can be used by a wireless device (e.g., wireless device 102) to uniquely identify an access network (e.g., WLAN 150) that supports emergency telecommunication (calling) services.

Access networks (ANPs) that are part of the roaming federation provided via identity federation 110 and that support the emergency-RCOI, such as WLAN 150, can configure the emergency-RCOI on WLAN equipment, such as on radio node 154 and/or WLC 152. In some embodiments, WLAN equipment providers can augment existing OpenRoaming provisioning interfaces with emergency-RCOI settings. Thus, an access network, such as WLAN 150, may allow any wireless devices that may not have access credentials for authenticating with a traditional IDP, such as IDP 120-A, to connect to the access network for emergency calling.

In addition to supporting emergency calling services, WLAN 150 can also support indoor-localization services and mapping services via location/mapping service 156 in order to perform various operations discussed for embodiments herein.

During operation, consider that WLAN 150, via radio node 154, is configured to support the emergency-RCOI (E-RCOI) and broadcasts or otherwise advertises support of emergency telecommunication (calling) services by broadcasting/advertising the emergency-RCOI (E-RCOI) via radio node 154, as generally shown at 180 of FIG. 1A. In various embodiments, such emergency-RCOI broadcasts/advertisements may be provided via any combination of 802.11 beacon messages (e.g., 802.11u signaling including the emergency-RCOI in a beacon information element IE on the BSSID (Basic Service Set Identifier) of radio node 154) and/or via to any Access Network Query Protocol (ANQP) query/response exchanges between wireless device 102 and radio node 154 related to supported services, etc.

In one embodiment, OpenRoaming specifications may be enhanced to ensure that those ANPs that broadcast the emergency-RCOI do so on a separate WLAN such that WLANs may include the Public Land Mobile Network (PLMN) identifiers (PLMN-IDs) of a P5G access network in their beacons. A conventional Passpoint-defined Home Service Provider (SP) Preference can be used to ensure that users with valid OpenRoaming credentials (e.g., IDP 120-A wireless profile 104-2 to facilitate authentication with IDP 120-A) do not select the emergency-RCOI WLAN.

In accordance with embodiments herein, end devices, such as wireless device 102 operated by user 101, can be preconfigured with an emergency services wireless profile 104-1, as shown in FIG. 1A. In at least one embodiment, the emergency services wireless profile 104-1 may be implemented as a Wi-Fi Alliance emergency services Passpoint profile.

The emergency services wireless profile 104-1 may be configured to include the emergency-RCOI (e.g., E-911-RCOI or E-RCOI) 104-1a, which may be any unique 3-octet or 5-octet value or string that can be used to identify that WLAN 150 supports emergency calling services. The emergency services wireless profile 104-1 may also be configured to include a non-user-specific or common authentication identity 104-1b (i.e., an identity that is common to or the same for all devices being configured with the emergency services profile), such as “anonymous@sos.emergencysvc.org”, “anonymous@sos.dhs.org”, “@emergency911.dhs-designated.org”, or any appropriate (commonname@realm) non-user-specific/common identity.

Additionally, the emergency services wireless profile 104-1 (Passpoint profile) may be configured to include at least one common authentication credential (i.e., common authentication credential(s), such as a common password, a common certificate, etc. that is/are common to or the same/shared among all devices being configured with the emergency services profile) or manufacturer provided certificate (e.g., a certificate issued to the device including a unique serial number of the device, etc.) that can be used as credentials for the emergency services wireless profile, shown in FIG. 1A as common credential/manufacturer certificate 104-1c, in which the credentials can be utilized by a user to initiate an emergency call. During operation, an emergency services wireless profile, such as the emergency services wireless profile 104-1 can allow wireless devices, such as wireless device 102, to automatically discover and connect to access networks (ANPs) that support emergency telecommunication services.

In some instances, the term ‘credentials’ can be used to collectively refer to an authentication identity and authentication credentials for a wireless profile. Generally, credentials in authentication context allow an endpoint to present a user's identity and some secret element that a device shares with the network (e.g., a password, certificates, etc.). However, in accordance with embodiments herein shared credentials, which broadly in some instance can include a common or manufacturer-provided identity and common or manufacturer-provided credentials (e.g., username: Emergency-Caller; Password: e911), do not identify a specific user, as they are common or manufacturer-provided (i.e., non-user-specific) credentials. Common/manufacturer-provided credentials can be configured for wireless devices utilizing various techniques.

In some embodiments, wireless device ecosystem vendors can pre-configure the emergency services wireless profile 104-1 into wireless device 102 at the time of manufacturing or can push an updated profile using established carrier-bundle based provisioning. In some embodiments, if wireless device 102 is an enterprise managed device, enterprise information technology (IT) functionality for the enterprise entity managing the device may also be able to provision the emergency services wireless profile 104-1 into wireless device 102 along with other enterprise policies over MDM procedures.

The provisioned emergency services wireless profile 104-1 may be common for all devices/all devices of a particular manufacturer that may utilize emergency services via the system 100 of FIG. 1A. Stated differently, the emergency services wireless profile 104-1 may be referred to as an Emergency Services Passpoint profile that includes various key elements: a network identifier that that can be used to identify a network that supports emergency telecommunication (calling) services; common/manufacturer-provided (non-user-specific) credentials, which in some instances can be inclusive of both a common username/identity and common authentication credentials (e.g., password, certificate(s), etc.); and, in some instances, a locale element that can make the profile specific to a given regulatory domain/country. Regarding the locale element, wireless devices may have multiple elements for different domains/countries in which the user/device can be located. For example, a user/device may include locale elements for each of a United States (US) profile and a European Union (EU) profile such that based on where the user/device is located, the device can select an emergency services wireless profile based on the country in which the user/device is located (e.g., the operating system (OS) of devices already have location determination techniques, which could be extended to selection of a given emergency services wireless profile based on a locale element stored for the profile).

Based on the network identifier being the emergency-RCOI and the credentials being common/manufacturer-provided credentials, the profile is therefor considered a common/manufacturer-provided profile. Thus, an emergency services wireless profile, such as the emergency services wireless profile 104-1, allows any device with at least one emergency services wireless profile to discover access networks that support emergency telecommunication services and be able to use the network for emergency calls.

In at least one embodiment, an OS/emergency calling application 106 (app) can be configured for wireless device 102 in which the OS/emergency calling app 106 can include any application logic that enables the wireless device 102 to prioritize and select a federation-based emergency services wireless profile, such as the emergency services wireless profile 104-1 configured for the wireless device 102, upon user 101 interacting with or engaging the OS/emergency calling application 106 for the wireless device 102 (e.g., explicit dialing of 911/112, pressing a hotkey/combination of hotkeys such as invoking an SOS service by pressing value+power buttons or the like) such that the wireless device 102 can automatically initiate connection with an access network (AN), such as WLAN 150, that supports federation-based telecommunication services.

In at least one embodiment, a SIP user agent (UA) 108 may also be configured for wireless device 102, in accordance with Internet Engineering Task Force (IETF) Request For Comments (RFC) 3261, in order to facilitate emergency calling. As discussed in further detail herein, during operation, the SIP UA 108 may be able to discover emergency voice or telecommunication services and related configuration information from an access network with which wireless device is connected for an emergency call via communications involving the emergency services IDP network 130. For example, the SIP UA 108 can use a P/E-CSCF configuration for P/E-CSCF 138/140 obtained from emergency services IDP network 130 via WLAN 150 in order to perform an emergency call in accordance with embodiments herein.

Although certain embodiments herein are discussed with reference to SIP-based communications for various emergency calling operations, it is to be understood that embodiments as discussed herein may be extended/leveraged for use with any voice, video, and/or text communication systems and, thus, are not limited to SIP-based communications. Any other agents, functions, logic, etc. may be configured for a wireless device and/or a given communication system in order to facilitate emergency calling operations involving any other communication protocols utilizing the techniques as discussed and/or taught via embodiments herein.

Consider an example scenario in which user 101 via wireless device 102 initiates an emergency call via WLAN 150/radio node 154; the user 101/wireless device 102 can be referred to interchangeably herein as an emergency caller. During operation in accordance with embodiments herein, through the use of location/mapping service 156, the access network (WLAN 150) using indoor localization protocols and techniques can identify the location of an emergency caller, such as user 101/wireless device 102, in relation to the location of the radio node 154 to which wireless device 102 (emergency caller) is connected for a structure, such as building 148. This will allow the placement of the user 101/wireless device 102 (emergency caller) on an enterprise digital floor map of the building 148. In at least one embodiment, location/mapping service 156 can also determine/identify a location of the radio node 154 to which the user 101/wireless device 102 connects for the emergency call.

Further in accordance with embodiments herein, location/mapping service 156, using the identified location of the emergency caller user 101/wireless device 102 in combination with various structure/building-specific map information 158 can generate an enhanced/decorated URL/URI including various navigation map information that can be used to facilitate navigation to the user 101/wireless device 102 (emergency caller) by emergency personnel responding to the emergency call, referred to herein as the emergency navigation map URL/URI (also referenced as ‘emergency_navigation_map URL/URI’ or ‘emergency-navigation-map URL/URI’ herein).

The URL/URI generated by the WLAN 150 can be representative of a starting point and a target that can be used to enable navigation from the starting point to the target. In at least one instance, the starting point can be the entrance to the building 148 and the target can be the location of the user 101/wireless device 102 (emergency caller) determined based on indoor-localization techniques performed by localization/mapping service 156. The path URL will also identify the indoor digital floor map.

In at least one embodiment, an emergency navigation map URL can be generated by location/mapping service 156 that points to the digital map of a building/floor, as follows:
https://www.example.com/building/{building_id}/floor/{floor_number}/map/{map_url}/from/{entrance_id}/to/{destination_id}

For the URI shown above, a “map_url” can include a URL that points to the digital map of the building/floor. Various other information can be included in the emergency navigation map URL, such as an identifier for the building 148 that can be identified via a {building_id}, a floor number of the building that can be identified via a {floor_number}, and identifier of an entrance of the building that can be identified via a {entrance_id}, and the location of the target (emergency caller) that can be identified as a “destination” via a {destination_id}.

In one embodiment, a generated emergency navigation map URL can be provided in a human readable format, such that the URL itself can be sent to emergency services personnel, potential in combination with a map of a corresponding building/floor such that the emergency services personnel can navigate to an emergency caller by reading the emergency navigation map URL. An example of a URL that may be provided in a human readable format may be generated, as follows:
https://www.emergencyfloormap.enterprise.com/TasmanDrive-Building24-Secondfloor-Breakroom

Any location information can be used to identify the location of an emergency caller in accordance with embodiments herein, including, but not limited to, geo-spatial coordinates, such as latitude/longitude, Global Positioning System (GPS) coordinates, Cartesian coordinates, combinations thereof, and/or the like.

In another embodiment, a URL can be generated by location/mapping service 156 in which the map data that points to a digital map of a building/floor can be embedded into the URL, such as encoded_map_data that can be encoded in a base64 or any other representation of the building/floor map data, as follows:
https://www.example.com/building/{building_id}/floor/{floor_number}/map/{encoded_map_data}/from/{entrance_id}/to/{destination_id}

In another embodiment, a URL can be generated by location/mapping service 156 that includes geo-spatial coordinates for representing the starting point and target/destination points, as follows:
https://www.example.com/building/{building_id}/floor/{floor_number}/map/{encoded_map_data}/from/{latitude}, {longitude}/to/{latitude}, {longitude}

In another embodiment, a URL can be generated by location/mapping service 156 in which the URL is compressed and is represented as a short URL in which the de-referenced URL can include an encoded digital indoor navigation path to an emergency caller, as follows:
https://www.example.com/abcdef123

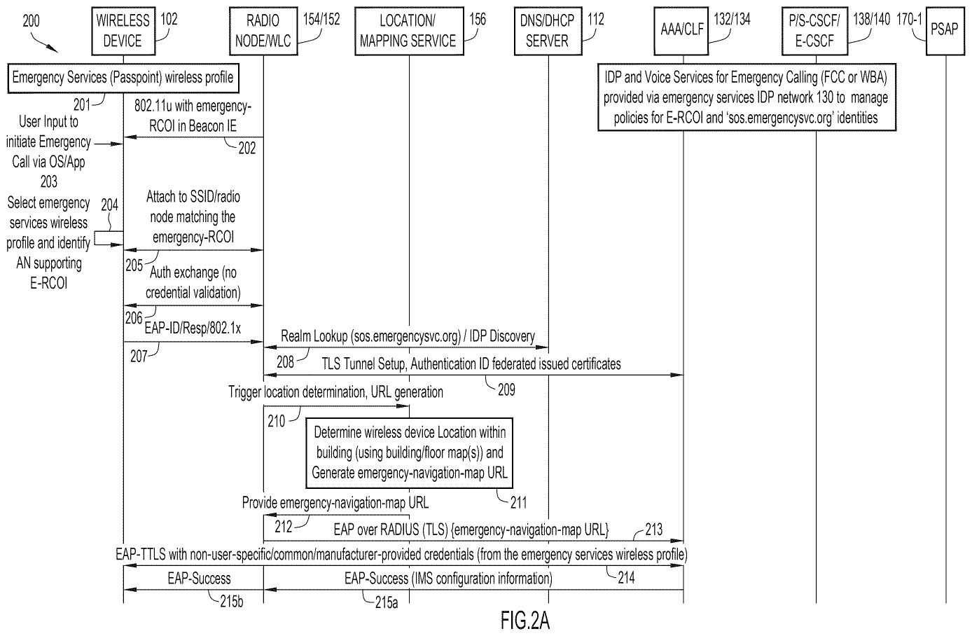

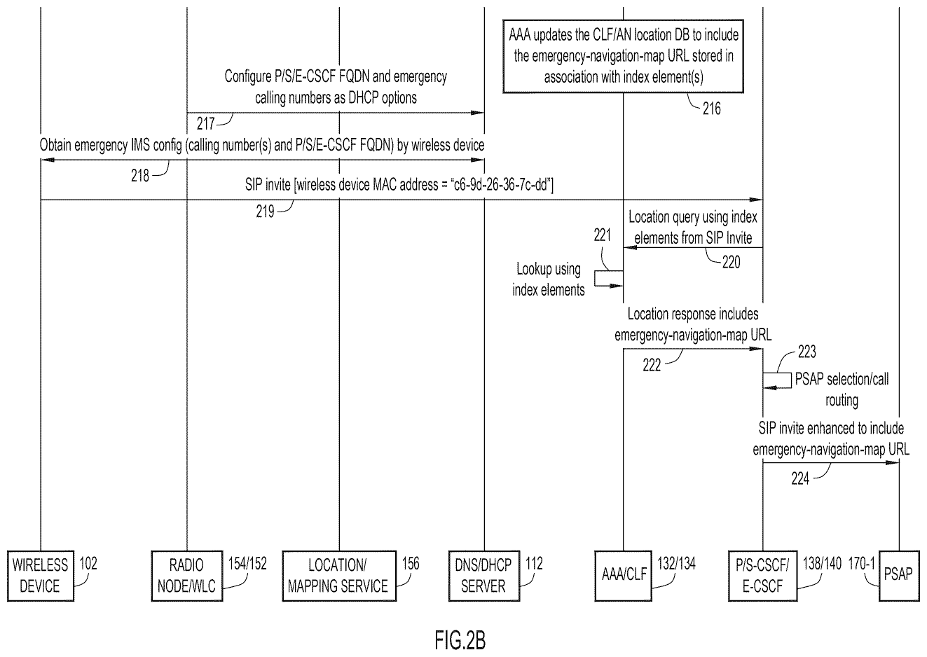

As discuss in further detail below with reference to FIGS. 2A and 2B, initiation of the emergency call by the user 101/wireless device 102 can trigger an 802.11 authentication procedure involving RADIUS signaling between the WLAN 150 and the AAA server 132/CLF 134 of the emergency services IDP network, such as Extensible Authentication Protocol (EAP) signaling over RADIUS. In accordance with embodiments herein, the WLAN 150 can signal a generated emergency navigation map URL to the AAA server 132/CLF 134 of the emergency services IDP network 130 in a RADIUS access request. In at least one embodiment, a new RADIUS attribute can be defined for allowing an ANP (e.g., WLAN 150) to signal an emergency navigation map URL to an IDP designated for an emergency calling realm (e.g., emergency services IDP network 130) or a vendor-specific RADIUS attribute, 26 with a corresponding sub-type, can be used to signal an emergency navigation map URL. Although FIGS. 2A and 2B are discussed with reference to URLs, it is to be understood that other types of URIs can be provided in accordance with embodiments herein.

The RADIUS protocol allows the exchange of attributes between non-Access Stratum (NAS), such as an AP/WLC and an authentication server, such as a RADIUS Server (e.g., AAA server 132). Each attribute has a specific meaning and definition. For example, the Calling-Station-Id typically includes the Media Access Control (MAC) address of the calling wireless device. For embodiments herein, an emergency navigation map URL can be sent as a new standardized RADIUS attribute or using a vendor-specific RADIUS attribute.

FIG. 1B is a diagram illustrating example details involving enhanced authentication signaling, such as enhanced RADIUS signaling 182, that can be signaled from WLAN 150 to AAA server 132/CLF 134 in which the signaling is enhanced to include an emergency navigation map URL 183 that can be generated in accordance with embodiments herein. In the present example, as shown in FIG. 1B, the emergency navigation map URL 183 may be formatted as follows: “https:/www.example.com/building/building24/floor/2/map/ayzbrada/from/lobbyentrance/to/breakroom”. It is to be understood that this is an example formatting only and is not meant to limit the broad scope of embodiments herein.

Per standards, the (enhanced) RADIUS signaling 182 can also include a MAC address 184 (Calling-Station-Id) for the wireless device 102. The MAC address of the radio node 154 (Called-Station-Id) is also included in the signaling, among other information. In some instances, the (enhanced) RADIUS signaling 182 can also include a framed IP address of the wireless device 102.

In some embodiments, the signaling can also include location information 185 for the wireless device 102/emergency caller and/or for the AP to which the wireless device is connected, as shown in FIG. 1B, as prescribed by RFC 5580. Such location information may include Location-Data that can be representative of the civic and/or geospatial location of a given AP and/or wireless device connected thereto.

Upon obtaining the authentication signaling from the WLAN 150, the AAA server 132, via CLF 134 can populate the AN location DB 136 to include the emergency navigation map URL 183. The CLF 134 can associate (in the AN location DB 136) the emergency navigation map URL 183 with one or more index elements, such as any combination of the identifying information for the wireless device 102, such as the MAC address for the wireless device 102, etc., identifying information of radio node 154 to which the wireless device is connected, such as the MAC address for the radio node 154, etc., a transport identity, such as an IP address for the wireless device 102 and/or an IP address for the radio node 154, and/or one or more explicit elements that may be present in a Private-Access-Network-Info (PANI or P-ANI) header that can be included in a SIP invite sent by the wireless device 102 for initiating an emergency call (once authenticated).

For example, consider that any combination of one or more of the following elements: <Client-MAC, AP-MAC, Client-IP, Location-Civic, Location-Geo, Emergency-Navigation-Map-URI, Timestamp> can be used to bind a given wireless device/client to a given AP and a given location of the user/wireless device.

IETF RFC 3455 defines conventional fields for a P-ANI header such as an “access-type” field that can be set to “IEEE-802.11ac” by the SIP UA 108 (access-type=IEEE-802.11ac) to indicate that the wireless device 102 is attached to WLAN 150. Other fields, such as an “access-info” field and an “extension-access-info” field may be used to carry information (as may be further specified in 3GPP TS 24.229), such as a node ID of radio node 154, that can be used to identify the WLAN 150 (e.g., generally, radio access network information) and/or the radio node 154 to which the wireless device 102 is connected, which can be stored as index element(s) in association with the emergency navigation map URL 183.

Storing the association between one or more index element elements and the URL allows the retrieval of the URL by the IMS system (e.g., P/S/E-CSCF) by passing any of the index element(s) that can be present in SIP signaling messages. For the present example, consider that the MAC address 184 of the wireless device 102 is stored in association with the emergency navigation map URL 183.

For example, with reference to FIG. 1C, FIG. 1C is a diagram illustrating example details for SIP signaling, such a SIP invite 186 (also referred to as a SIP invite message or SIP INVITE message) that can be used for initiating an emergency call by wireless device 102 (via SIP UA 108), in accordance with an example embodiment. When the emergency caller (wireless device 102) makes an emergency call, the SIP invite includes index elements that can be used by the IMS system, such as by CLF 134, for retrieving the emergency navigation map URL 183 from AN location DB 136.

For example, as shown in FIG. 1C, the SIP invite 186 includes the MAC address 184 of the wireless device 102 (within a “From” header field of the SIP invite). An IP address 187 (10.10.1.1 in this example) of the wireless device 102 is also included in a header of the SIP invite, along with a P-ANI header 188 that can include any combination of elements per standards.

In some instances, a Secure-Location-Tag (SLT) (or location tag) can also be included in the P-ANI header 188. In at least one instance, an SLT may be similar to a One Time Password (OTP) in that the SLT may be a dynamically generated string (potentially an alpha-numeric string, such as “SLT<LOC678ABC>” or any other string) having a lifetime validity that may not exceed the authorized session lifetime for a given IDP, such as the emergency services IDP network 130. In some instances, an SLT can be dynamically generated to be unique for each wireless device connecting to a given WLAN supporting emergency telecommunication services, such as WLAN 150. In still some instances, an SLT can be generated such that it can be common to all wireless devices connecting to a given radio node (and location thereof) of a given WLAN supporting emergency services at a given point in time, such as connecting to radio node 154 of WLAN 150 at a given point in time. Thus, an SLT may be representative of the location of a given wireless device, such as wireless device 102, or may be representative of the location of the radio node with which a wireless device is connected for an emergency call, such as radio node 154 with which the wireless device 102 is connected for the present example.

An SLT can potentially be generated by the WLAN 150 for wireless device 102 and included in RADIUS signaling to the emergency services IDP network 130 during authentication of the wireless device 102, in which the SLT can be stored as an index element for the wireless device in association with the emergency navigation map URL 183.

Upon obtaining the SIP invite 186, the CLF 134, when queried by the E-CSCF 140, can use information from the signaling, such as the MAC address 184 of the wireless device 102 (or any other index element(s) that may be configured for use within system 100, such as the wireless device 102 IP address, a Secure-Location-Tag (SLT), etc.), in order to query/retrieve the corresponding emergency navigation map URL 183 from the AN location DB 136 (assuming the MAC address 184 of the wireless device is stored in association with the emergency navigation map URL 183 in the AN location DB 136). The CLF 134 can provide the emergency navigation map URL 183 to the E-CSCF 140, which can enhance the SIP invite 186 that is to be sent to a service or device to include the emergency navigation map URL 183.

For example, with reference to FIG. 1D, FIG. 1D is a diagram illustrating example details for an enhanced SIP invite 186′ that is enhanced to the emergency navigation map URL (183, from FIG. 1B). The enhanced SIP invite 186′ can be sent to a service (such as to PSAP 170-1) or a device (such as directly to one or more emergency personnel) to enable navigation of emergency personnel to an emergency caller, such as to user 101/wireless device 102, in accordance with an example embodiment.

Thus, the emergency IMS system can insert the retrieved emergency navigation map URL 183 (or URI, if applicable) into a SIP header prior to forwarding the emergency call to a service or device. In at least one embodiment, an emergency navigation map URL can be inserted into a Contact header of a SIP invite message. In at least one embodiment, an emergency navigation map URL 183 can be inserted into a Route header of a SIP invite message. In at least one embodiment, an emergency navigation map URL 183 can be inserted into a caller ID header of a SIP invite message.

Upon obtaining an emergency navigation map URL 183, a service or device can generate navigation path information to enable emergency services personnel to navigate from the entrance of the building 148 (or a floor thereof) to the location of the user 101/wireless device 102 within the building/floor, as encoded via the emergency navigation map URL 183. For example, the elements of the emergency navigation map URL 183 will be sufficient for the PSAP 170-1, via navigation service 172-2, to generate an indoor navigation path to enable emergency services personnel to navigate to the caller (user 101/wireless device 102) from the entrance of the venue/building 148.

For example, FIG. 1E is a diagram illustrating example details for an example digital map 192 that can be generated based on the emergency navigation map URL 183 that can be obtained via the enhanced SIP invite 186′ in which the digital map 192 can display a navigation path 193 from an entrance of the structure to the emergency caller (user 101/wireless device 102), shown in a geo-spatial area 194 in FIG. 1E, in accordance with an example embodiment.

In at least one embodiment, a generated navigation path can be represented as a series of waypoints or a continuous route that guides the user from the starting location to the destination. These waypoints may include specific instructions like “turn left at the break room,” “take the elevator to the second floor,” “walk 50 meters straight,” or the like. The navigation path can be displayed visually on the digital map, showing the user (e.g., emergency services personnel) the route they need to follow. In some embodiments, a generated navigation path can be integrated into a user interface provided by a third-party service, device, etc., such as being integrated into a Cisco® Spaces dashboard that can display navigation path information. Cisco® is a registered trademark of Cisco Systems, Inc. Any navigation service now known in the art or hereinafter developed can be utilized to generate a navigation path based on information received and/or obtained via an emergency navigation map URL as discussed for embodiments herein.

In some embodiments, an emergency navigation map URL (or URI, if applicable) can be sent directly to emergency services personnel device in which an emergency responder can read a human-readable string if navigation information in order to locate an emergency caller. In some embodiments, an emergency navigation map URL can be sent directly to emergency services personnel device in which the URL can be ‘clicked’ by an emergency services responder in order to trigger a navigation service to display a digital map/waypoints, etc. for a navigation path that leads to an emergency caller. In some embodiments, an emergency navigation map URL can be sent directly to emergency services personnel in which the URL is encoded in a quick response (QR) code that can trigger a navigation service to display a digital map/waypoints, etc. for a navigation path that leads to an emergency caller.

In some embodiments, a navigation service and/or device can track movement of an emergency responder in relation to a navigation path (e.g., generated from/based on an emergency navigation map URL) that leads to an emergency caller such that real-time navigation can be provided to the emergency responder to enable the emergency responder to locate the emergency caller.

For various operations that may be performed via system 100 in order to facilitate emergency telecommunication services and application driven profile prioritization, consider FIGS. 2A and 2B which are a message sequence diagram 200 illustrating various operations that may be performed to facilitate emergency telecommunication services and application driven profile prioritization for system 100 of FIG. 1A, according to various example embodiments.

FIGS. 2A and 2B include wireless device 102, DNS/DHCP server 112, radio node/WLC 154/152 and location/mapping service 156 of WLAN 150. Also shown in FIGS. 2A and 2B are AAA server 132/CLF (which may be a combined entity or collocated with each other), P/S-CSCF 138, and E-CSCF 140 of emergency services IDP network 130 and PSAP 170-1.

During operation, consider that WLAN 150, via radio node 154 is configured to support the emergency-RCOI (E-RCOI) and broadcasts or otherwise advertises support of emergency telecommunication (calling) services by broadcasting/advertising the emergency-RCOI (E-RCOI) via radio node 154, as generally shown at 180 of FIG. 1A. In various embodiments, such emergency-RCOI broadcasts/advertisements may be provided via any combination of 802.11 beacon messages (e.g., 802.11u signaling including the emergency-RCOI in a beacon information element IE on the BSSID of radio node 154) and/or via to any Access Network Query Protocol (ANQP) query/response exchanges between wireless device 102 and radio node 154 related to supported services, etc., as generally illustrated at 202 of FIG. 2A.

In one embodiment, OpenRoaming specifications may be enhanced to ensure that those ANPs that broadcast the emergency-RCOI do so on a separate WLAN such that WLANs may include the Public Land Mobile Network (PLMN) identifiers (PLMN-IDs) in their beacons. A conventional Passpoint-defined Home Service Provider (SP) Preference can be used to ensure that users with valid OpenRoaming credentials (e.g., IDP 120-A wireless profile 104-2 to facilitate authentication with IDP 120-A) do not select the emergency-RCOI WLAN.

In accordance with embodiments herein, end devices, such as wireless device 102 operated by user 101, can be preconfigured with an emergency services wireless profile 104-1, as shown in FIG. 1A and as generally shown at 201 of FIG. 2A. In at least one embodiment, the emergency services wireless profile 104-1 may be implemented as a Wi-Fi Alliance emergency services Passpoint profile. IDP and voice services for Emergency Calling (e.g., DHS or WBA), such as voice IMS services, can be provided via emergency services IDP network 130, which can manage policies for E-RCOI and ‘sos.emergencysvc.org’ identities for the present example.

Consider, in an illustrative example, that user 101 provides a user input, as generally illustrated at 203 of FIG. 2A, via a user interface (UI) of wireless device 102 provided via the OS/emergency calling application 106 in order to trigger an emergency call being initiated by wireless device 102. In at least one embodiment, the user input to initiate or trigger the emergency call may include selecting an “Emergency Call” button, pressing one or more hotkeys, by dialing an emergency phone number (e.g., 911, 112, etc.), or the like via a UI provided by the wireless device 102 via the OS/emergency calling application 106.

In the present example, it is assumed that wireless device 102 is not currently connected to a public cellular access network prior to the user 101 providing the user input to initiate the emergency call. Further for the present example, it is assumed that wireless device 102 is within the coverage area of WLAN 150/radio node 154 but may not have any valid access network credentials (e.g., not configured with another, non-emergency services IDP, provided wireless profile) that may otherwise facilitate connection of the wireless device 102 to WLAN 150.

Although some embodiments herein are discussed with reference to wireless devices that may not have valid (OpenRoaming) credentials (e.g., to perform a federation-based authentication with a non-emergency services identity provider), it is to be understood that embodiments herein may be equally applicable to scenarios in which wireless devices may have valid WLAN credentials. In still some instances, embodiments herein may find applicability to scenarios in which wireless devices may be in the coverage of a public cellular access network.

Thus, embodiments herein may be utilized in a variety of network environments. For example, one environment may encompass telecommunications service provider-owned Wi-Fi access points in which other communications technologies may be operating on unlicensed spectrum, available to the public for access to emergency calling services, without requiring traditional login credentials, during times of emergency, when mobile service is unavailable. Another environment may encompass non-telecommunications service provider-owned Wi-Fi access points of public access to emergency calling services when mobile service is unavailable. Yet another environment may encompass other alternative means of providing the public with access to emergency calling services during times of emergency when mobile service is unavailable. Accordingly, embodiments herein may be utilized in a variety of different network environments.

Returning to the present example, upon receiving the user 101 input (203) via the OS/emergency calling application 106, the wireless device 102 can identify and select the emergency services wireless profile 104-1 to utilize for the emergency call, potentially including selection of a corresponding profile based on a locale and a number of locale elements provisioned for multiple emergency services wireless profiles that can be configured for the wireless devices for different countries/domains. Upon selecting the emergency services wireless profile 104-1 for the emergency call, wireless device 102 via the OS/emergency calling application 106 identifies the emergency-RCOI contained in the emergency services wireless profile 104-1 in order to discover/identify an access network that supports emergency telecommunication services based on such an access network broadcasting/advertising the emergency-RCOI (e.g., broadly, an emergency services access network identifier).

For example, as generally illustrated at 204, upon receiving the user 101 input (203), the wireless device 102, via the OS/emergency calling application 106, can automatically identify and select the emergency services wireless profile 104-1 to use for the emergency call and then can identify the emergency-RCOI (E-RCOI) broadcast/advertised via WLAN 150/radio node 154 (180) in order discover and initiate connection with radio node 154 for initiating the emergency call. For example, as shown at 205, wireless device 102 can initiate a network-attach with the Service Set Identifier (SSID)/radio node 154 broadcasting the matching emergency-RCOI for emergency-call access. If the device is already connected to Wi-Fi over a BSSID, possibly selected due to an RCOI that does not support emergency services (e.g., an RCOI contained in IDP 120-A wireless profile 104-2), the operations at 205 may include re-selection of the WLAN 150/radio node 154 supporting the emergency-RCOI.

Embodiments herein provide for defining the re-use of the well supported EAP-TTLS (Extensible Authentication Protocol (EAP)-Tunneled Transport Layer Security (TTLS)) process with a common set of credential(s), as may be provided via the emergency services wireless profile 104-1, that can be used by wireless device 102 that may seek access on the emergency-RCOI via WLAN 150. In one embodiment, the EAP-Identity for wireless device 102 may be specified as “anonymous@sos.emergencysvc.org” (or any other appropriate “commonname@realm” authentication identity) with the common authentication credential(s) of the emergency services wireless profile 104-1 being used in the EAP inner method (i.e., the EAP exchange consisting of an outer method involving a common network address identifier (NAI) that only exposes the realm to the access network (e.g., sos.emergencysvc.org) that is used to setup a TLS tunnel (which hides identity exposure to the access network) in which the tunnel, via the inner method, is used to send a further identity that is protected between the supplicant (e.g., wireless device 102) and an EAP-Server (e.g. AAA server 132)).

As shown at 206, wireless device 102 can initiate an initial (EAP) authentication message exchange with radio node 154. As shown at 207, wireless device 102 sends an EAP identity (EAP-ID), EAP-ID response, or 802.1x authentication message including the common/default authentication identity 104-1b, “anonymous@sos.emergencysvc.org” (or other similarly defined emergency services ‘name@realm’, which for the emergency services involves a common/non-user-specific NAI) from the emergency services wireless profile 104-1.

OpenRoaming provides for dynamically discovering signaling peers used to authenticate end-users using DNS operations. In at least one embodiment, similar approaches may be utilized by ANPs, such as WLAN 150, in order to discover the signaling systems, such as emergency services IDP network 130 that are to be used to support the EAP-server for the “@sos.emergencysvc.org” realm, such as AAA server 132.

For example, as shown at 208, radio node 154/WLC 152 may perform a realm lookup via the DNS server (of DNS/DHCP server 112) using the realm portion of the EAP-ID sent by wireless device 102 (e.g., “sos.emergencysvc.org”) in order to identify the AAA server 132 for emergency services IDP network 130 supporting EAP authentication for the emergency-RCOI and the realm.

Following the emergency services IDP discovery at 208, the radio node 154/WLC may perform tunnel establishment with the AAA server 132, as generally shown at 209, in order to establish a secure Transport Layer Security (TLS) tunnel with the AAA server 132 for securing 802.1x/EAP traffic that is to be exchanged between the wireless device 102 and the emergency services IDP network 130/AAA server 132.

As shown at 210, the radio node 154/WLC 152 can trigger location/mapping service 156 to determine the location of wireless device 102 and generate an emergency navigation map URL as illustrated at 211, such as the emergency navigation map URL 183 discussed above. For the message sequence diagram, the URL is referred to as ‘emergency-navigation-map URL’. The emergency-navigation-map URL can be provided to the radio node 154/WLC 152, as shown at 212. In some embodiments, the location of the wireless device 102 may also be provided to the radio node 154/WLC. In some embodiments, location/mapping service can be implemented via radio node 154 and/or via WLC 152.

As discussed in further detail below with reference to communications at 213, 214a and 214b, the wireless device 102 is to complete the EAP authentication with AAA server 132 using the common authentication credential/manufacturer certificate 104-1c of the emergency services wireless profile 104-1. Thus, the AAA server 132 (e.g., EAP server), can use the common/manufacturer-provided credential(s) (e.g., 104-1c) of the emergency services wireless profile 104-1 in order to authenticate user 101/wireless device 102 onto WLAN 150 for instances in which the wireless device may or may not have valid identity federation (e.g., OpenRoaming) credentials to otherwise connect to WLAN 150. 802.1x/EAP messages for the authentication exchange can be tunneled as RADIUS messages between the radio node 154 and the AAA server 132.

In accordance with embodiments herein, as shown at 214, radio node 154/WLC 152 can initiate an EAP authentication for wireless device 102 with the AAA server 132 over RADIUS via the TLS tunnel previously established with the AAA server 132. Along with conventional EAP-based information to initiate the authentication, the RADIUS signaling towards the AAA server 132 can include the identifier of radio node 154, such as BSSID (and potentially SSID), a MAC address, and/or IP address. A MAC address/IP address of the wireless device 102. A location of the wireless device 102 and/or a location of radio node 154 may also be included in the RADIUS signaling in some instances. In some instances, the location of the wireless device 102 can be included in RFC 5580 defined location attributes (e.g., in attribute 127/128) in the RADIUS signaling.

In accordance with embodiments herein, the RADIUS signaling towards the AAA server 132 can also be enhanced to include the emergency-navigation-map URL (e.g., emergency navigation map URL 183), for example, as shown in FIG. 1B.

Thereafter, as shown at 214, an EAP-TTLS authentication exchange can be carried out between wireless device 102 and the AAA server 132 using the non-user-specific/common credential(s) contained in the emergency services wireless profile 104-1. Upon a successful EAP transaction/authentication being performed for the wireless device 102, an EAP-SUCCESS message can be sent from the AAA server 132 toward wireless device 102 via radio node 154 in which the EAP-SUCCESS message sent to radio node 154, as shown at 215a, can include the emergency voice calling (IMS) configuration information, such as the FQDN of a CSCF of the emergency services IDP network 130, such as any combination of the P/S-CSCF 138/E-CSCF 140, and can include at least one emergency calling number that the wireless device 102 can utilize to perform the emergency call. The EAP-SUCCESS message can be further transmitted to the wireless device 102 (without the emergency voice calling (IMS) configuration information), as shown at 215b.

Moving to FIG. 2B, as shown at 216, the AAA server 132 updates the CLF 134, which in turn updates the AN location DB 136 (not shown in FIG. 2B), with the emergency-navigation-map URL that can be stored in association with one or more index elements, such as any combination of the identifying information for the wireless device 102 (e.g., MAC address, etc.), identifying information for the radio node 154 to which the wireless device 102 is connected (e.g., MAC address, etc.), a transport identity (e.g., IP address) for the wireless device 102 and/or for the radio node 154, and/or one or more explicit elements that may be present in a P-ANI header that can be included in a SIP invite message sent by the wireless device 102 for initiating an emergency call. Thus, the emergency-navigation-map URL can be stored in a mapping with one or more index elements that correlates the various information such that it can be retrieved upon obtaining a SIP invite for initiating IMS voice services for an emergency call of the wireless device 102.

For the present example, consider that an index element stored in the AN location DB 136 by CLF 134 in association with the emergency-navigation-map URL (183 of FIG. 1B) is set to the MAC address of the wireless device 102 (184 of FIG. 1B), such as “c6-9d-26-36-7c-dd” identified in the RADIUS signaling (213), for example, as shown in FIG. 1B. Other index element(s) can be stored in association with a given emergency navigation map URL in accordance with embodiments herein (e.g., wireless device 102 IP address, civic/geolocation information, SLT, AP IP/MAC address, etc.).

The radio node 154 can deliver the emergency voice calling (IMS) configuration information to the wireless device 102 over any corresponding interface using any appropriate technique. For example, in at least one embodiment, DHCP communications may be utilized to deliver the configuration information to the wireless device 102. For example, as shown at 217, the radio node 154 can signal the DHCP server (of DNS/DHCP server 112) to configure the DHCP server with the emergency voice calling (IMS) configuration information such that through signaling with the DHCP server for address assignment procedures for the wireless device 102, as shown at 218, the emergency voice calling (IMS) configuration information can be sent to the wireless device 102. Other variations for delivering IMS configuration information to a wireless device can be envisioned, such as via DHCP intercept operations that may be performed by the radio node 154/WLC 152 in which a DHCP response to the wireless device can be augmented to include the configuration information and/or any other mechanism for delivering an IMS configuration to a wireless device.

As shown at 219, the wireless device 102 can send a SIP invite to the P/S-CSCF 138 (which can send the SIP invite to the E-CSCF 140) in which the SIP invite (e.g., as illustrated for FIG. 1C) includes, among other information, a “From” field including the MAC address of the wireless device 102 (e.g., “c6-9d-26-36-7c-dd” as shown in FIG. 1C), among other information as discussed for embodiments herein.

As shown at 220, the E-CSCF 140 performs a location query towards the CLF 134 that includes one or more index elements from the SIP invite, such as the MAC address of the wireless device 102. The CLF 134 performs a look-up on the information stored via AN location DB 136 using the index element(s) (e.g., wireless device 102 MAC address), as shown at 221. Based on the look-up using the index element, a location response is sent to the E-CSCF 140 that includes the emergency-navigation-map URL (183), as shown at 222. As shown at 223, the E-CSCF 140 can perform PSAP selection and call routing (using IMS standards-based procedures) to identify PSAP 170-1 to which to direct the emergency call from wireless device 102.

Although the example of FIGS. 2A and 2B discusses performing a query on the AN location DB 136 via CLF 134 based on one or more index elements obtained via a SIP invite (e.g., via headers of the SIP invite, via a P-ANI header of the SIP invite, etc.), it is to be understood that one or more index elements may be identified from any SIP signaling that may be performed between the wireless device 102, WLAN 150, and emergency services IDP network 130.

As shown at 224, the E-CSCF enhances the SIP invite to include the emergency-navigation-map URL, for example, emergency navigation map URL 183 as shown in FIG. 1D and sends the SIP invite including the emergency navigation map URL 183 to the PSAP 170-1. In at least one embodiment, the PSAP 170-1, via navigation service 172-1 (not shown), can generate navigation path information using a floor map of the building 148 as either embedded within the URL or pointed-to within the URL (using a map URL for obtaining the floor map of the building), the entrance of the building as encoded in the URL, and the location of the emergency caller (wireless device 102) within the building 148 as encoded in the URL. In at least one embodiment, the navigation path information may include a digital floor map of the building for the location of the emergency caller that can enhanced with a navigation path (e.g., as shown in FIG. 1E) that leads from the entrance of the building to the location of the emergency caller and/or that can be enhanced with any other path information, directions, etc. in order to enable emergency services personnel to quickly/easily navigate to the caller. The digital floor map/navigation path can be sent to electronic devices (e.g., phones, tablets, etc.) of the emergency personnel and dynamically generated via one or more user interfaces (UIs) of the devices by the PSAP 170-1 in at least one embodiment.

Although PSAP 170-1 is shown for the present example, it is to be understood that any emergency navigation map URL can be sent directly to one or more emergency personnel devices in accordance with embodiments herein.

In at least one embodiment, an emergency navigation map URL can be inserted by voice functions (e.g., E-CSCF) of the emergency services IDP network 130. A receiver of the call (i.e., a callee), such as emergency services personnel, can receive this URL encoded into the caller identifier (ID) or as part of some other SIP header message. In some instances, the URL can point to a navigation service (e.g., navigation service 172-1) that can generate map(s) and/or provide instruction(s) for reaching the caller's location. In some instances, the callee can load this URL into a web browser, which can provide voice guided navigation / way-finding to enable the callee to reach the caller.

Thus, through embodiments herein enterprises, schools, or venue operators can be provided a simple web-based navigation service. When the URL is accessed, passing parameters that identify the caller location, a navigation service can steer the user. In some other examples, the voice server (e.g., E-CSCF) can distribute the URL to the public safety personal through out-of-band mechanisms.

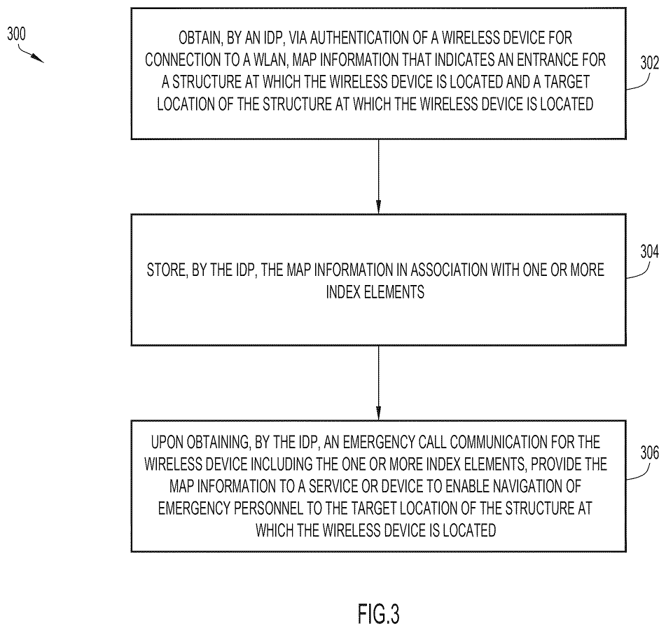

Referring to FIG. 3, FIG. 3 is a flow chart depicting a method 300, according to an example embodiment. In various embodiments, method 300 illustrates operations that may be performed at least in part by an emergency services IDP network, such as a AAA server, a CLF, a CSCF (e.g., AAA server 132, CLF 134, P/S-CSCF, and E-CSCF 140 of emergency services IDP network 130), and/or any combination thereof, in order to facilitate enhancing emergency call signaling with navigation information for locating an emergency caller in accordance with embodiments herein.

At 302, the method may include, for a wireless device capable of connection to a WLAN that has initiated emergency communications facilitated by an identity provider (IDP), obtaining, by the IDP, via authentication of the wireless device for connection to the WLAN, navigation map information that indicates an entrance for a structure at which the wireless device is located and a target location of (within) the structure at which the wireless device is located. In at least one embodiment, the authentication may involve authentication signaling obtained by an AAA server (e.g., AAA server 132) of the IDP, such as RADIUS signaling obtained from a WLAN with which the wireless device seeks connection in which the RADIUS signaling is enhanced to include the navigation map information in a RADIUS attribute. The target location of the structure can be a floor map location for a floor of the structure at which the wireless device is located. The navigation map information can be encoded in a URL (or in a URI) in accordance with embodiments herein.

The navigation map information can further include an indication of a digital map of an area of the structure at which the wireless device is located. In one instance, the indication of the digital map is a URL identifying a network location from which the digital map is capable of being obtained. In one instance, the indication of the digital map is encoded data from which the digital map is capable of being generated.

At 304, the method may include storing, by the IDP, the navigation map information in association with one or more index elements. In at least one embodiment, the one or more index elements are included along with the navigation map information for the authentication of the wireless device for connection to the WLAN. The one or more index elements may include any combination of at least one of an IP address and/or a MAC address of the wireless device; at least one of an IP address and/or a MAC address of a WLAN radio node with which the wireless device is connected; or radio access network information for the WLAN. The navigation map information and one or more index elements stored in association therewith can be stored by a CLF via an access network (AN) location DB for the IDP.

At 306, the method may include upon obtaining, by the IDP, an emergency call communication for the wireless device including the one or more index elements, providing the navigation map information to a service or device to enable navigation of emergency personnel to the target location of the structure at which the wireless device is located. In at least one embodiment, the emergency call communication is a SIP invite communication including at least one of the one or more index elements in which the SIP invite communication is obtained by a call session control function (CSCF) of the IDP, such as by a P/S-CSCF and then an E-CSCF, in which the E-CSCF triggers a location function of the IDP (e.g., a CLF) to obtain the stored navigation map information for the wireless device using the one or more index elements. In at least one embodiment, obtaining the stored navigation map information for the wireless device may include performing a lookup on a stored location including a plurality of navigation map information for a plurality of wireless devices (such as via a database (e.g., AN location DB)) using the one or more index elements included in the emergency call communication in order to obtain the navigation map information for the wireless device from the stored location.

In at least one embodiment, the service to which the navigation map information is provided may be a PSAP in which the method may further include communicating, by the PSAP, the navigation map information to a navigation service, wherein the navigation service generates navigation path information based on the entrance of the structure, the target location of the structure at which the wireless device is located, and a digital map of an area of the structure at which the wireless device is located in which the navigation path information enables the emergency services personnel to navigate to the target location of the structure at which the wireless device is located along a navigation path for the structure.

In at least one embodiment, the device to which the navigation map information is provides is an emergency services personnel device that enables the emergency services personnel device to generate or obtain navigation path information based on the entrance of the structure, the target location of the structure at which the wireless device is located, and a digital map of an area of the structure at which the wireless device is located in which the navigation path information enables the emergency services personnel to navigate to the target location of the structure at which the wireless device is located along a navigation path for the structure.

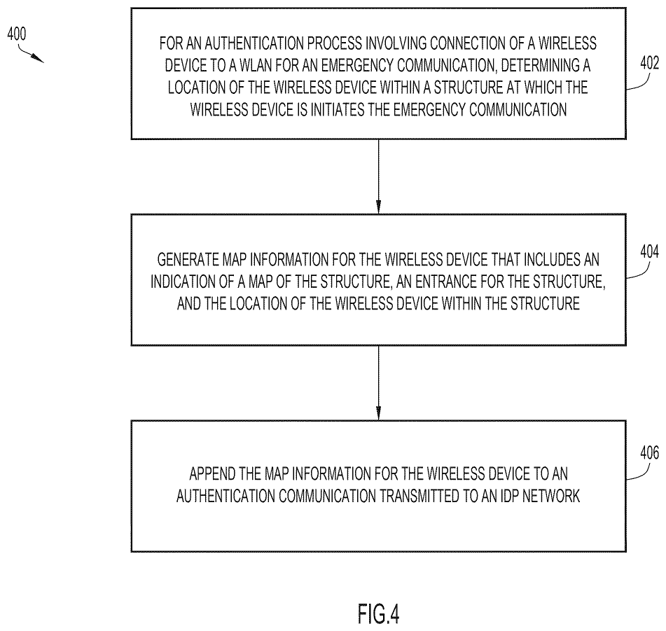

Referring to FIG. 4, FIG. 4 is a flow chart depicting a method 400, according to an example embodiment. In at least one embodiment, method 400 illustrates operations that may be performed at least in part by an access network provider (ANP), such as a P5G or WLAN provider, in order to facilitate enhancing emergency call signaling with navigation information for locating an emergency caller in accordance with embodiments herein. In various embodiments embodiment, method 400 may be performed by any of a WLAN radio node (e.g., radio node 154), a WLC (e.g., WLC 152), a location/mapping service for a WLAN (e.g., location mapping service 156), and/or any combination thereof.

At 402, the method may include, for an authentication process involving connection of a wireless device to a WLAN for an emergency communication, determining a location of the wireless device (e.g., as shown at 211 of FIG. 2A) within a structure at which the wireless device initiates the emergency communication.

At 404, the method may include generating navigation map information for the wireless device (e.g., as shown at 211 of FIG. 2A) that includes an indication of a map of the structure, an entrance for the structure, and the location of the wireless device within the structure. In at least one embodiment, generating the navigation map information may include encoding an indication of a digital map of the structure, the entrance of the structure, and the target location of the structure within a URI or URL (e.g., within an emergency navigation map URI or a URL). The digital map of the structure may be a digital map of a floor of the structure at which the wireless device is initiating the emergency communication.

At 406, the method may include transmitting an authentication communication that includes the navigation map information to an identity provider network. (that is to facilitate emergency services communications, such as to AAA server 132 of emergency services IDP network 130). In at least one embodiment, the authentication communication involves an EAP over RADIUS communication in which the navigation map information is appended to the RADIUS communication as a RADIUS attribute.

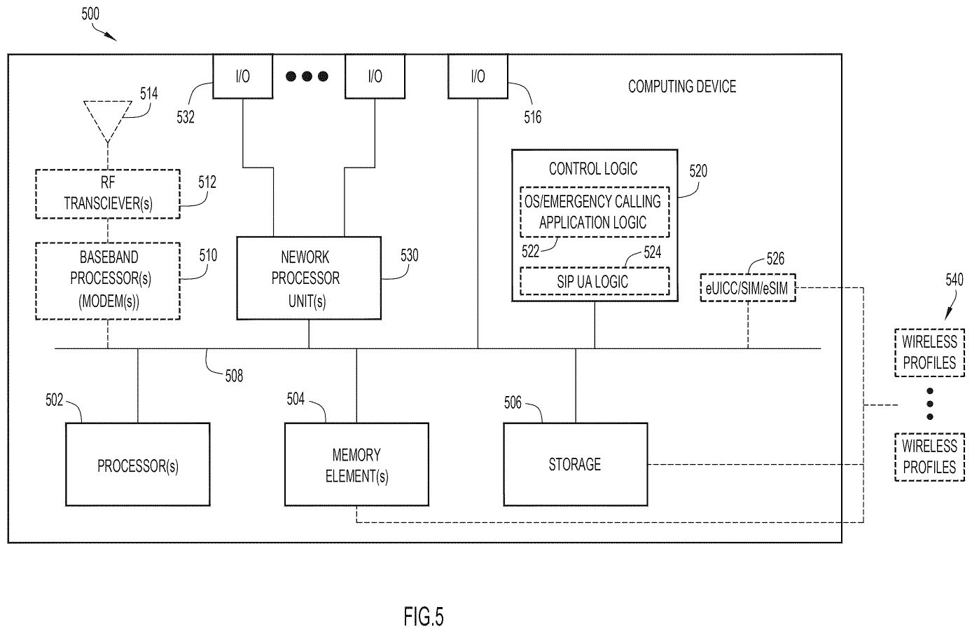

Referring to FIG. 5, FIG. 5 illustrates a hardware block diagram of a computing device 500 that may perform functions associated with operations discussed herein in connection with the techniques depicted via FIGS. 1A-1E, 2A-2B, 3, and 4. In various embodiments, a computing device or apparatus, such as computing device 500 or any combination of computing devices 500, may be configured as any entity/entities as discussed for the techniques depicted in connection with operations illustrated/discussed for various embodiments herein, such as, wireless device 102, radio node 154, WLC 152, DNS/DHCP server 112, AAA server 132, CLF 134 (potentially inclusive of AN location DB 136), P/S-CSCF 138, E-CSCF 140, PSAP 170-1, and/or any other elements/functions/nodes discussed herein.

In at least one embodiment, the computing device 500 may be any apparatus that may include one or more processor(s) 502, one or more memory element(s) 504, storage 506, a bus 508, one or more network processor unit(s) 530 interconnected with one or more network input/output (I/O) interface(s) 532, one or more I/O interface(s) 516, and control logic 520. For embodiments in which computing device 500 may be implemented as a wireless device or UE, such as wireless device 102, control logic 520 may include OS/emergency calling application logic 522 and SIP UA logic 524. In various embodiments, instructions associated with logic for computing device 500 can overlap in any manner and are not limited to the specific allocation of instructions and/or operations described herein.

For embodiments in which computing device 500 may be implemented as any device capable of wireless communications (e.g., wireless device 102, radio node 154, and radio node 164), computing device 500 may further include at least one baseband processor or modem 510, one or more radio RF transceiver(s) 512 (e.g., any combination of RF receiver(s) and RF transmitter(s)), one or more antenna(s) or antenna array(s) 514.

Additionally, for embodiments in which computing device 500 may be implemented as a wireless device/user equipment (UE) or the like, computing device 500 may include any combination of an Embedded Universal Integrated Circuit Card (eUICC), Subscriber Identity Module (SIM) (sometimes referred to as Subscriber Identification Module) card, and/or embedded SIM (eSIM) 526. As also illustrated in FIG. 5, one or more wireless profile(s) 540 can be configured for any combination of memory element(s) and/or storage 506, for non-SIM based (e.g., Passpoint) wireless profiles, and/or for the eUICC/SIM/eSIM 526, for SIM-based (e.g., public/private 3GPP/cellular) wireless profiles.

In at least one embodiment, processor(s) 502 is/are at least one hardware processor configured to execute various tasks, operations, and/or functions for computing device 500 as described herein according to software and/or instructions configured for computing device 500. Processor(s) 502 (e.g., a hardware processor) can execute any type of instructions associated with data to achieve the operations detailed herein. In one example, processor(s) 502 can transform an element or an article (e.g., data, information) from one state or thing to another state or thing. Any of potential processing elements, microprocessors, digital signal processor, baseband signal processor, modem, PHY, controllers, systems, managers, logic, and/or machines described herein can be construed as being encompassed within the broad term ‘processor’.

In at least one embodiment, memory element(s) 504 and/or storage 506 is/are configured to store data, information, software, and/or instructions associated with computing device 500, and/or logic configured for memory element(s) 504 and/or storage 506. For example, any logic described herein (e.g., control logic 520, OS/emergency calling application logic 522, OS/emergency calling application 106, SIP UA logic 524, and SIP UA 108) can, in various embodiments, be stored for computing device 500 using any combination of memory element(s) 504 and/or storage 506. Note that in some embodiments, storage 506 can be consolidated with memory element(s) 504 (or vice versa) or can overlap/exist in any other suitable manner.

In at least one embodiment, bus 508 can be configured as an interface that enables one or more elements of computing device 500 to communicate in order to exchange information and/or data. Bus 508 can be implemented with any architecture designed for passing control, data and/or information between processors, memory elements/storage, peripheral devices, and/or any other hardware and/or software components that may be configured for computing device 500. In at least one embodiment, bus 508 may be implemented as a fast kernel-hosted interconnect, potentially using shared memory between processes (e.g., logic), which can enable efficient communication paths between the processes.

In various embodiments, network processor unit(s) 530 may enable communication between computing device 500 and other systems, entities, etc., via network I/O interface(s) 532 (wired and/or wireless) to facilitate operations discussed for various embodiments described herein. In various embodiments, network processor unit(s) 530 can be configured as a combination of hardware and/or software, such as one or more Ethernet driver(s) and/or controller(s) or interface cards, Fibre Channel (e.g., optical) driver(s) and/or controller(s), wireless receivers/transmitters/transceivers, baseband processor(s)/modem(s), and/or other similar network interface driver(s) and/or controller(s) now known or hereafter developed to enable communications between computing device 500 and other systems, entities, etc. to facilitate operations for various embodiments described herein. In various embodiments, network I/O interface(s) 532 can be configured as one or more Ethernet port(s), Fibre Channel ports, any other I/O port(s), and/or antenna(s)/antenna array(s) now known or hereafter developed. Thus, the network processor unit(s) 530 and/or network I/O interface(s) 532 may include suitable interfaces for receiving, transmitting, and/or otherwise communicating data and/or information (wired and/or wirelessly) in a network environment.

I/O interface(s) 516 may allow for input and output of data and/or information with other entities that may be connected to computing device 500. For example, I/O interface(s) 516 may provide a connection to external devices such as a keyboard, keypad, a touch screen, and/or any other suitable input and/or output device now known or hereafter developed. In some instances, external devices can also include portable computer readable (non-transitory) storage media such as database systems, thumb drives, portable optical or magnetic disks, and memory cards. In still some instances, external devices can be a mechanism to display data to a user, such as, for example, a computer monitor, a display screen, or the like.

For embodiments in which computing device 500 is implemented as a wireless device or any apparatus capable of wireless communications, the RF transceiver(s) 512 may perform RF transmission and RF reception of wireless signals via antenna(s)/antenna array(s) 514, and the baseband processor or modem 510 performs baseband modulation and demodulation, etc. associated with such signals to enable wireless communications for computing device 500.

In various embodiments, control logic 520 and, if provided, OS/calling application logic 522 and SIP UA logic 524, can include instructions that, when executed, cause processor(s) 502 to perform operations, which can include, but not be limited to, providing overall control operations of computing device; interacting with other entities, systems, etc. described herein; maintaining and/or interacting with stored data, information, parameters, etc. (e.g., memory element(s), storage, data structures, databases, tables, etc.); combinations thereof; and/or the like to facilitate various operations for embodiments described herein.

The programs described herein (e.g., control logic 520, etc.) may be identified based upon application(s) for which they are implemented in a specific embodiment. However, it should be appreciated that any particular program nomenclature herein is used merely for convenience; thus, embodiments herein should not be limited to use(s) solely described in any specific application(s) identified and/or implied by such nomenclature.

In various embodiments, any entity or apparatus as described herein may store data/information in any suitable volatile and/or non-volatile memory item (e.g., magnetic hard disk drive, solid state hard drive, semiconductor storage device, random access memory (RAM), read only memory (ROM), erasable programmable read only memory (EPROM), application specific integrated circuit (ASIC), etc.), software, logic (fixed logic, hardware logic, programmable logic, analog logic, digital logic), hardware, and/or in any other suitable component, device, element, and/or object as may be appropriate. Any of the memory items discussed herein should be construed as being encompassed within the broad term ‘memory element’. Data/information being tracked and/or sent to one or more entities as discussed herein could be provided in any database, table, register, list, cache, storage, and/or storage structure: all of which can be referenced at any suitable timeframe. Any such storage options may also be included within the broad term ‘memory element’as used herein.

Note that in certain example implementations, operations as set forth herein may be implemented by logic encoded in one or more tangible media that is capable of storing instructions and/or digital information and may be inclusive of non-transitory tangible media and/or non-transitory computer readable storage media (e.g., embedded logic provided in: an ASIC, digital signal processing (DSP) instructions, software [potentially inclusive of object code and source code], etc.) for execution by one or more processor(s), and/or other similar machine, etc. Generally, memory element(s) 504 and/or storage 506 can store data, software, code, instructions (e.g., processor instructions), logic, parameters, combinations thereof, and/or the like used for operations described herein. This includes memory element(s) 504 and/or storage 506 being able to store data, software, code, instructions (e.g., processor instructions), logic, parameters, combinations thereof, or the like that are executed to carry out operations in accordance with teachings of the present disclosure.

In some instances, software of the present embodiments may be available via a non-transitory computer useable medium (e.g., magnetic or optical mediums, magneto-optic mediums, CD-ROM, DVD, memory devices, etc.) of a stationary or portable program product apparatus, downloadable file(s), file wrapper(s), object(s), package(s), container(s), and/or the like. In some instances, non-transitory computer readable storage media may also be removable. For example, a removable hard drive may be used for memory/storage in some implementations. Other examples may include optical and magnetic disks, thumb drives, and smart cards that can be inserted and/or otherwise connected to a computing device for transfer onto another computer readable storage medium.

In one form, a computer-implemented method is provided in which, for a wireless device capable of connection to a wireless local area network (WLAN) that has initiated emergency communications facilitated by an identity provider (IDP), the computer-implemented method may include obtaining, by the IDP, via authentication of the wireless device for connection to the WLAN, navigation map information that indicates an entrance for a structure at which the wireless device is located and a target location of the structure at which the wireless device is located; storing, by the IDP, the navigation map information in association with one or more index elements; and upon obtaining, by the IDP, an emergency call communication for the wireless device including the one or more index elements, providing the navigation map information to a service or device to enable navigation of emergency personnel to the target location of the structure at which the wireless device is located.

In at least one instance, the one or more index elements and the navigation map information are included in an authentication communication for authentication of the wireless device for connection to the WLAN that is obtained by an authentication service of the IDP.

In at least one instance, the authentication communication is a Remote Authentication Dial-In User Service (RADIUS) communication, and the navigation map information is included as a RADIUS attribute within the RADIUS communication.

In at least one instance, the emergency call communication is a Session Initiation Protocol (SIP) invite communication including at least one of the one or more index elements in which the SIP invite communication is obtained by a call session control function (CSCF) of the IDP that triggers a location function of the IDP to obtain the stored navigation map information using the one or more index elements.

In at least one instance, the navigation map information further includes an indication of a digital map of an area of the structure at which the wireless device is located. In at least one instance, the indication of the digital map is a Uniform Resource Locator (URL) identifying a network location from which the digital map is capable of being obtained. In at least one instance, the indication of the digital map is encoded data from which the digital map is capable of being generated. In at least one instance, navigation map information is encoded in a Uniform Resource Locator (URL) or a Uniform Resource Identifier (URI).

In at least one instance, the target location of the structure is a floor map location for a floor of the structure at which the wireless device is located.

In at least one instance, the one or more index elements comprise at least one of: at least one of an Internet Protocol (IP) address or a Media Access Control (MAC) address of the wireless device; at least one of an Internet Protocol (IP) address or a Media Access Control (MAC) address of a WLAN radio node with which the wireless device is connected; or radio access network information for the WLAN.

In at least one instance, the service to which the navigation map information is provided is a Public Safety Answering Point (PSAP), in which the computer-implemented method further comprises communicating, by the PSAP, the navigation map information to a navigation service, wherein the navigation service generates navigation path information based on the entrance of the structure, the target location of the structure at which the wireless device is located, and a digital map of an area of the structure at which the wireless device is located in which the navigation path information enables the emergency services personnel to navigate to the target location of the structure at which the wireless device is located along a navigation path for the structure.

In at least one instance, the device to which the map information is provided is an emergency services personnel device that enables the emergency services personnel device to generate or obtain navigation path information based on the entrance of the structure, the target location of the structure at which the wireless device is located, and a digital map of an area of the structure at which the wireless device is located in which the navigation path information enables the emergency services personnel to navigate to the target location of the structure at which the wireless device is located along a navigation path for the structure.

In one form, one or more non-transitory computer readable storage media encoded with instructions are provided that, when executed by a processor, cause the processor to perform operations, comprising: for a wireless device capable of connection to a wireless local area network (WLAN) that has initiated emergency communications facilitated by an identity provider (IDP), obtaining, by the IDP, via authentication of the wireless device for connection to the WLAN, navigation map information that indicates an entrance for a structure at which the wireless device is located and a target location of the structure at which the wireless device is located; storing, by the IDP, the navigation map information in association with one or more index elements; and upon obtaining, by the IDP, an emergency call communication for the wireless device including the one or more index elements, providing the navigation map information to a service or device to enable navigation of emergency personnel to the target location of the structure at which the wireless device is located.

In one form, another computer-implemented method is provided in which, for an authentication process involving connection of a wireless device to a wireless local area network (WLAN) for an emergency communication, the computer-implemented method may include determining a location of the wireless device within a structure at which the wireless device initiates the emergency communication; generating navigation map information for the wireless device that includes an indication of a map of the structure, an entrance for the structure, and the location of the wireless device within the structure; and transmitting an authentication communication that includes the navigation map information to an identity provider network.

In at least one instance, the indication of the map of the structure is a Uniform Resource Locator (URL) identifying a network location from which the map of the structure is capable of being obtained. In at least one instance, the indication of the map of the structure is encoded data from which the map of the structure is capable of being generated. In at least one instance, the map information is encoded in a Uniform Resource Locator (URL) or a Uniform Resource Identifier (URI). In at least one instance, the authentication communication is a Remote Authentication Dial-In User Service (RADIUS) communication, and the navigation map information is included as a RADIUS attribute within the RADIUS communication.

In one form, one or more non-transitory computer readable storage media encoded with instructions are provided that, when executed by a processor, cause the processor to perform operations, comprising: for an authentication process involving connection of a wireless device to a wireless local area network (WLAN) for an emergency communication, determining a location of the wireless device within a structure at which the wireless device initiates the emergency communication; generating navigation map information for the wireless device that includes an indication of a map of the structure, an entrance for the structure, and the location of the wireless device within the structure; and transmitting an authentication communication that includes the navigation map information to an identity provider network.

### Variations and Implementations

Embodiments described herein may include one or more networks, which can represent a series of points and/or network elements of interconnected communication paths for receiving and/or transmitting messages (e.g., packets of information) that propagate through the one or more networks. These network elements offer communicative interfaces that facilitate communications between the network elements. A network can include any number of hardware and/or software elements coupled to (and in communication with) each other through a communication medium. Such networks can include, but are not limited to, any local area network (LAN), virtual LAN (VLAN), wide area network (WAN) (e.g., the Internet), software defined WAN (SD-WAN), wireless local area (WLA) access network, wireless wide area (WWA) access network, metropolitan area network (MAN), Intranet, Extranet, virtual private network (VPN), Low Power Network (LPN), Low Power Wide Area Network (LPWAN), Machine to Machine (M2M) network, Internet of Things (IoT) network, Ethernet network/switching system, any other appropriate architecture and/or system that facilitates communications in a network environment, and/or any suitable combination thereof.

Networks through which communications propagate can use any suitable technologies for communications including wireless communications (e.g., 4G/5G/nG, IEEE 802.11 (e.g., Wi-Fi®/Wi-Fi 6®), IEEE 802.16 (e.g., Worldwide Interoperability for Microwave Access (WiMAX)), Radio-Frequency Identification (RFID), Near Field Communication (NFC), Bluetooth™, mm.wave, Ultra-Wideband (UWB), etc.), and/or wired communications (e.g., T1 lines, T3 lines, digital subscriber lines (DSL), Ethernet, Fibre Channel, etc.). Generally, any suitable means of communications may be used such as electric, sound, light, infrared, and/or radio to facilitate communications through one or more networks in accordance with embodiments herein. Communications, interactions, operations, etc. as discussed for various embodiments described herein may be performed among entities that may directly or indirectly connected utilizing any algorithms, communication protocols, interfaces, etc. (proprietary and/or non-proprietary) that allow for the exchange of data and/or information.

In various example implementations, any entity or apparatus for various embodiments described herein can encompass network elements (which can include virtualized network elements, functions, etc.) such as, for example, network appliances, forwarders, routers, servers, switches, gateways, bridges, loadbalancers, firewalls, processors, modules, radio receivers/transmitters, or any other suitable device, component, element, or object operable to exchange information that facilitates or otherwise helps to facilitate various operations in a network environment as described for various embodiments herein. Note that with the examples provided herein, interaction may be described in terms of one, two, three, or four entities. However, this has been done for purposes of clarity, simplicity and example only. The examples provided should not limit the scope or inhibit the broad teachings of systems, networks, etc. described herein as potentially applied to a myriad of other architectures.

Communications in a network environment can be referred to herein as ‘messages’, ‘messaging’, ‘signaling’, ‘data’, ‘content’, ‘objects’, ‘requests’, ‘queries’, ‘responses’, ‘replies’, etc. which may be inclusive of packets. As referred to herein and in the claims, the term ‘packet’ may be used in a generic sense to include packets, frames, segments, datagrams, and/or any other generic units that may be used to transmit communications in a network environment. Generally, a packet is a formatted unit of data that can contain control or routing information (e.g., source and destination address, source and destination port, etc.) and data, which is also sometimes referred to as a ‘payload’, ‘data payload’, and variations thereof. In some embodiments, control or routing information, management information, or the like can be included in packet fields, such as within header(s) and/or trailer(s) of packets. Internet Protocol (IP) addresses discussed herein and, in the claims, can include any IP version 4(IPv 4 ) and/or IP version 6(IPv 6 ) addresses.

To the extent that embodiments presented herein relate to the storage of data, the embodiments may employ any number of any conventional or other databases, data stores or storage structures (e.g., files, databases, data structures, data or other repositories, etc.) to store information.

Note that in this Specification, references to various features (e.g., elements, structures, nodes, modules, components, engines, logic, steps, operations, functions, characteristics, etc.) included in ‘one embodiment’, ‘example embodiment’, ‘an embodiment’, ‘another embodiment’, ‘certain embodiments’, ‘some embodiments’, ‘various embodiments’, ‘other embodiments’, ‘alternative embodiment’, and the like are intended to mean that any such features are included in one or more embodiments of the present disclosure, but may or may not necessarily be combined in the same embodiments. Note also that a module, engine, client, controller, function, service, logic or the like as used herein in this Specification, can be inclusive of an executable file comprising instructions that can be understood and processed on a server, computer, processor, machine, compute node, combinations thereof, or the like and may further include library modules loaded during execution, object files, system files, hardware logic, software logic, or any other executable modules.

It is also noted that the operations and steps described with reference to the preceding figures illustrate only some of the possible scenarios that may be executed by one or more entities discussed herein. Some of these operations may be deleted or removed where appropriate, or these steps may be modified or changed considerably without departing from the scope of the presented concepts. In addition, the timing and sequence of these operations may be altered considerably and still achieve the results taught in this disclosure. The preceding operational flows have been offered for purposes of example and discussion. Substantial flexibility is provided by the embodiments in that any suitable arrangements, chronologies, configurations, and timing mechanisms may be provided without departing from the teachings of the discussed concepts.

As used herein, unless expressly stated to the contrary, use of the phrase ‘at least one of’, ‘one or more of’, ‘and/or’, variations thereof, or the like are open-ended expressions that are both conjunctive and disjunctive in operation for any and all possible combination of the associated listed items. For example, each of the expressions ‘at least one of X, Y and Z’, ‘at least one of X, Y or Z’, ‘one or more of X, Y and Z’, ‘one or more of X, Y or Z’ and ‘X, Y and/or Z’ can mean any of the following: 1) X, but not Y and not Z; 2) Y, but not X and not Z; 3) Z, but not X and not Y; 4) X and Y, but not Z; 5) X and Z, but not Y; 6) Y and Z, but not X; or 7) X, Y, and Z.

Each example embodiment disclosed herein has been included to present one or more different features. However, all disclosed example embodiments are designed to work together as part of a single larger system or method. This disclosure explicitly envisions compound embodiments that combine multiple previously discussed features in different example embodiments into a single system or method.

Additionally, unless expressly stated to the contrary, the terms ‘first’, ‘second’, ‘third’, etc., are intended to distinguish the particular nouns they modify (e.g., element, condition, node, module, activity, operation, etc.). Unless expressly stated to the contrary, the use of these terms is not intended to indicate any type of order, rank, importance, temporal sequence, or hierarchy of the modified noun. For example, ‘first X’ and ‘second X’ are intended to designate two ‘X’ elements that are not necessarily limited by any order, rank, importance, temporal sequence, or hierarchy of the two elements. Further as referred to herein, ‘at least one of’ and ‘one or more of’ can be represented using the ‘(s)’nomenclature (e.g., one or more element(s)).

One or more advantages described herein are not meant to suggest that any one of the embodiments described herein necessarily provides all of the described advantages or that all the embodiments of the present disclosure necessarily provide any one of the described advantages. Numerous other changes, substitutions, variations, alterations, and/or modifications may be ascertained to one skilled in the art and it is intended that the present disclosure encompass all such changes, substitutions, variations, alterations, and/or modifications as falling within the scope of the appended claims.

What is claimed is:

1. A method comprising:
for a wireless device capable of connection to a wireless local area network (WLAN) that has initiated emergency communications facilitated by an identity provider (IDP):
obtaining, by the IDP, via authentication of the wireless device for connection to the WLAN, navigation map information that indicates an entrance for a structure at which the wireless device is located and a target location of the structure at which the wireless device is located;
storing, by the IDP, the navigation map information in association with one or more index elements; and
upon obtaining, by the IDP, an emergency call communication for the wireless device including the one or more index elements, providing the navigation map information to a service or device to enable navigation of emergency personnel to the target location of the structure at which the wireless device is located.

2. The method of claim 1, wherein the one or more index elements and the navigation map information are included in an authentication communication for authentication of the wireless device for connection to the WLAN that is obtained by an authentication service of the IDP.

3. The method of claim 2, wherein the authentication communication is a Remote Authentication Dial-In User Service (RADIUS) communication, and the navigation map information is included as a RADIUS attribute within the RADIUS communication.

4. The method of claim 1, wherein the emergency call communication is a Session Initiation Protocol (SIP) invite communication including at least one of the one or more index elements in which the SIP invite communication is obtained by a call session control function (CSCF) of the IDP that triggers a location function of the IDP to obtain the stored navigation map information using the one or more index elements.

5. The method of claim 1, wherein the navigation map information further includes an indication of a digital map of an area of the structure at which the wireless device is located.

6. The method of claim 5, wherein the indication of the digital map is a Uniform Resource Locator (URL) identifying a network location from which the digital map is capable of being obtained.

7. The method of claim 6, wherein the indication of the digital map is encoded data from which the digital map is capable of being generated.

8. The method of claim 1, wherein the navigation map information is encoded in a Uniform Resource Identifier (URI) or a Uniform Resource Locator (URL).

9. The method of claim 1, wherein the target location of the structure is a floor map location for a floor of the structure at which the wireless device is located.

10. The method of claim 1, wherein the one or more index elements comprise at least one of:
at least one of an Internet Protocol (IP) address or a Media Access Control (MAC) address of the wireless device;
at least one of an Internet Protocol (IP) address or a Media Access Control (MAC) address of a WLAN radio node with which the wireless device is connected; or
radio access network information for the WLAN.

11. The method of claim 1, wherein the service to which the navigation map information is provided is a Public Safety Answering Point (PSAP), the method further comprising:
communicating, by the PSAP, the navigation map information to a navigation service, wherein the navigation service generates navigation path information based on the entrance of the structure, the target location of the structure at which the wireless device is located, and a digital map of an area of the structure at which the wireless device is located in which the navigation path information enables the emergency personnel to navigate to the target location of the structure at which the wireless device is located along a navigation path for the structure.

12. The method of claim 1, wherein the device to which the navigation map information is provided is an emergency services personnel device that enables the emergency services personnel device to generate or obtain navigation path information based on the entrance of the structure, the target location of the structure at which the wireless device is located, and a digital map of an area of the structure at which the wireless device is located in which the navigation path information enables the emergency personnel to navigate to the target location of the structure at which the wireless device is located along a navigation path for the structure.

13. A method comprising:
for an authentication process involving connection of a wireless device to a wireless local area network (WLAN) for an emergency communication:
determining a location of the wireless device within a structure at which the wireless device initiates the emergency communication;
generating navigation map information for the wireless device that includes an indication of a map of the structure, an entrance for the structure, and the location of the wireless device within the structure; and
transmitting an authentication communication that includes the navigation map information to an identity provider network.

14. The method of claim 13, wherein the indication of the map of the structure is a Uniform Resource Locator (URL) identifying a network location from which the map of the structure is capable of being obtained.

15. The method of claim 13, wherein the indication of the map of the structure is encoded data from which the map of the structure is capable of being generated.

16. The method of claim 13, wherein the navigation map information is encoded in a Uniform Resource Identifier (URI) or a Uniform Resource Locator (URL).

17. The method of claim 13, wherein the authentication communication is a Remote Authentication Dial-In User Service (RADIUS) communication, and the navigation map information is included as a RADIUS attribute within the RADIUS communication.

18. An apparatus comprising:
at least one memory element for storing data; and
at least one processor for executing instructions associated with the data, wherein executing the instructions causes the apparatus to perform operations, comprising:
for a wireless device capable of connection to a wireless local area network (WLAN) that has initiated emergency communications facilitated by an identity provider (IDP):
obtaining, by the IDP, via authentication of the wireless device for connection to the WLAN, navigation map information that indicates an entrance for a structure at which the wireless device is located and a target location of the structure at which the wireless device is located;
storing, by the IDP, the navigation map information in association with one or more index elements; and
upon obtaining, by the IDP, an emergency call communication for the wireless device including the one or more index elements, providing the navigation map information to a service or device to enable navigation of emergency personnel to the target location of the structure at which the wireless device is located.

19. The apparatus of claim 18, wherein the one or more index elements and the navigation map information are included in an authentication communication for authentication of the wireless device for connection to the WLAN that is obtained by an authentication service of the IDP.

20. The apparatus of claim 19, wherein the authentication communication is a Remote Authentication Dial-In User Service (RADIUS) communication, and the navigation map information is included as a RADIUS attribute within the RADIUS communication.
